(19) United States
(12) Patent Application Publication
(10) Pub. No.: US 2009/0086338 A1
(43) Pub. Date: Apr. 2, 2009

(54) High Aperture Folded Catadioptric Projection Objective

(75) Inventor: Alexander EPPLE, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 11/864,490

(22) Filed: Sep. 28, 2007

(51) Int. Cl. G02B 17/08

(52) U.S. Cl. 359/728; 359/730

(57) ABSTRACT

A catadioptric projection objective with telecentric image space has a first objective part configured to image the pattern from the object surface into a first intermediate image, and having a first pupil surface, a second objective part configured to image the first intermediate image into a second intermediate image, and having a second pupil surface optically conjugate to the first pupil surface, the second objective part including a concave mirror having a reflective mirror surface positioned at or close to the second pupil surface, and a third objective part configured to image the second intermediate image into the image surface, and having a third pupil surface optically conjugate to the first and second pupil surface. The concave mirror is arranged coaxial with the first objective part to receive radiation from the object surface, a first deflecting mirror is arranged to deflect radiation reflected from the concave mirror towards a second deflecting mirror, and the second deflecting mirror is arranged to deflect radiation from the first deflecting mirror towards the image surface such that the image surface is parallel to the object surface. The projection objective has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength.

### BACKGROUND OF THE INVENTION

1. Field of the Invention

The invention relates to a catadioptric projection objective which may be used in a microlithographic projection exposure apparatus to expose a radiation-sensitive substrate arranged in the region of an image surface of the projection objective with at least one image of pattern of a mask that is arranged in the region of an object surface of the projection objective. The invention also relates to a projection exposure apparatus which includes such catadioptric projection objective.

2. Description of the Related Art

Microlithographic projection exposure methods and apparatus are used to fabricate semiconductor components and other finely patterned components. A microlithographic exposure process involves using a mask (reticle) that carries or forms a pattern of a structure to be imaged, for example a line pattern of a layer of a semiconductor component. The pattern is positioned in a projection exposure apparatus between an illumination system and a projection objective in a region of the object surface of the projection objective. Primary radiation from the ultraviolet electromagnetic spectrum (UV radiation) is provided by a primary radiation source and transformed by optical components of the illumination system to produce illumination radiation directed at the pattern of the mask. The radiation modified by the mask and the pattern passes through the projection objective, which forms an image of the pattern in the image surface of the projection objective, where a substrate to be exposed is arranged. The substrate, e.g. a semiconductor wafer, normally carries a radiation-sensitive layer (photoresist).

In order to create even finer structures, it is sought to both increase the image-side numerical aperture (NA) of the projection objective and employ shorter wavelengths, preferably ultraviolet radiation with wavelengths less than about 260 nm, for example 248 nm, 193 nm or 157 nm.

Purely refractive projection objectives have been predominantly used for optical lithography in the past. However, correction of elementary aberrations, such as correction of chromatic aberrations and correction for the Petzval sum (image field curvature) become more difficult as NA is increased and shorter wavelengths are used.

One approach for obtaining a flat image surface and good correction of chromatic aberrations is the use of catadioptric optical systems, which combine both refracting elements, such as lenses, and reflecting elements with optical power, such as at least one concave mirror. While the contributions of positive-powered and negative-powered lenses in an optical system to overall power, image field curvature and chromatic aberrations are opposite to each other, a concave mirror has positive power like a positive-powered lens, but the opposite effect on image field curvature without contributing to chromatic aberrations.

A concave mirror is difficult to integrate into an optical system, since it sends the radiation right back in the direction it came from. Configurations integrating a concave mirror without causing problems due to beam vignetting and pupil obscuration are desirable.

A variety of concepts with specific advantages and drawbacks have been used in the past. Catadioptic projection objectives without intermediate image or with one or more real intermediate images have been designed. Separation of a projection beam section directed at a concave mirror and a projection beam section reflected by a concave mirror may be accomplished in a variety of ways. Polarization selective physical beam splitting may be employed. Alternatively, geometrical beam separation may be employed, for example by using one or more planar deflecting mirrors to fold the optical axis of the projection objective. Catadioptric projection objectives with one straight, unfolded optical axis have also been designed.

Further, the overall size of the optical systems both with regard to diameter and with regard to system length tends to increase as the image-side NA is increased. In this regard, high prices of transparent materials with sufficient optical quality and sizes large enough for fabricating large lenses represent problems. Additionally, installation space for incorporating a projection objective into a microlithographic projection exposure apparatus may be limited. Therefore, measures that allow reducing the number and sizes of lenses and simultaneously contribute to maintaining, or even improving, imaging fidelity are desired.

### SUMMARY OF THE INVENTION

It is one object of the invention to provide a catadioptric projection objective which allows very high resolution to be achieved, with a compact design with optimized dimensions.

It is another object of the invention to provide catadioptric projection objectives suitable for immersion lithography at image side numerical apertures of at least NA=1.35 having moderate size and material consumption.

To address these and other objects the invention, according to one formulation of the invention, provides a catadioptric projection objective comprising:

a plurality of optical elements arranged along an optical axis to image a pattern from an object field in an object surface of the objective to an image field in an image surface region of the objective at an image-side numerical aperture NA with electromagnetic radiation defining an operating wavelength λ, including:

a first objective part configured to image the pattern from the object surface into a first intermediate image, and having a first pupil surface;

a second objective part configured to image the first intermediate image into a second intermediate image, and having a second pupil surface optically conjugate to the first pupil surface, the second objective part including a concave mirror having a reflective mirror surface positioned at or close to the second pupil surface;

a third objective part configured to image the second intermediate image into the image surface, and having a third pupil surface optically conjugate to the first and second pupil surface;

wherein the concave mirror is arranged coaxial with the first objective part to receive radiation from the object surface;

a first deflecting mirror is arranged to deflect radiation reflected from the concave mirror towards a second deflecting mirror;

the second deflecting mirror is arranged to deflect radiation from the first deflecting mirror towards the image surface such that the image surface is parallel to the object surface,

wherein the projection objective has an immersion lens group having a convex object-side entry surface bounding at a gas or vacuum and an image-side exit surface in contact with an immersion liquid in operation,

wherein the immersion lens group is at least partly made of a high-index material with refractive index n≧1.6 at the operating wavelength.

It has been found that a catadioptric projection objective having two real intermediate images may be designed to obtain very high image-side numerical aperture in an image field large enough to allow microlithographic applications while avoiding problems such as vignetting. Further, where an off-axis object field and an image field are used, pupil obscuration can also be avoided in systems having high image-side NA. The projection objective may have exactly three consecutive objective parts and exactly two real intermediate images. Each of the first to third objective part may be an imaging subsystem performing two consecutive Fourier-transformations (2f-system), and there may be no additional objective part in addition to the first to third objective parts. Where exactly two real intermediate images are provided, a large number of degrees of freedom for the optical designer is provided in optical systems which may be manufactured with reasonable size and complexity. Large image side numerical apertures in image fields suitable for lithographic purpose are made possible.

Embodiments of projection objectives configured to be used in lithography are essentially telecentric in image space, i.e. the exit pupil is located essentially at infinity. This determines the position of the pupil surfaces in the subsystems being the conjugate planes to the exit pupil at infinity. The object space may be essentially telecentric as well, thus providing an entrance pupil essentially at infinity.

The second objective part includes a concave mirror having a reflective mirror surface positioned at or close to the second pupil surface. The first and the third objective part may be purely dioptric (lenses only). The second objective part may include one or more lenses in addition to the concave mirror, thereby forming a catadioptric second objective part.

A negative group comprising at least one negative lens may be arranged in front of the concave mirror on a reflecting side thereof in a double pass region such that radiation passes at least twice in opposite directions through the negative group. The negative group may be positioned in direct proximity to the concave pupil mirror in a region near the pupil surface, where this region may be characterized by the fact that the marginal ray height (MRH) of the imaging is greater than the chief ray height (CRH). Preferably, the marginal ray height is at least twice as large, in particular at least 5 to 10 times as large, as the chief ray height in the region of the negative group. A negative group in the region of large marginal ray heights can contribute effectively to the chromatic correction, in particular to the correction of the axial chromatic aberration, since the axial chromatic aberration of a thin lens is proportional to the square of the marginal ray height at the location of the lens (and proportional to the refractive power and to the dispersion of the lens). Added to this is the fact that the projection radiation passes twice, in opposite through-radiating directions, through a negative group arranged in direct proximity to a concave mirror, with the result that the chromatically overcorrecting effect of the negative group is utilized twice. The negative group may e.g. consist of a single negative lens or contain at least two negative lenses.

The concave mirror is arranged coaxial with the first objective part to receive radiation from the object surface via the first intermediate image. A first deflecting mirror is arranged to deflect radiation reflected from the concave mirror towards a second deflecting mirror. The second deflecting mirror is arranged to deflect radiation coming from the first deflecting mirror towards the image surface such that the image surface is parallel to the object surface. To this end, planar reflecting surfaces of the deflecting mirrors may be arranged at right angles relative to each other. In this folding geometry, a first section of the optical axis is defined between the object surface and the concave mirror, a second section of the optical axis is defined transverse to the first section of the optical axis between the first and the second deflecting mirror, and a third section of the optical axis, parallel to the first section of the optical axis, is defined between the second deflecting mirror and the image surface. Optical elements aligned along the first section of the optical axis may be mounted in a first mounting structure (barrel). Optical elements aligned along the third section of the optical axis may be mounted in a second mounting structure (barrel) parallel to and laterally offset to the first mounting structure. A transverse mounting structure between the deflecting mirrors at both ends may connect the parallel mounting structures. Projection objectives according to this general folding geometry are sometimes denoted as “two-barrel designs” and may be characterized by a general shape corresponding to the character “h”.

A first beam section formed by radiation coming from the object plane towards the concave mirror may be guided in the space between the deflecting mirrors such that a second beam section leading from the concave mirror towards the image surface crosses the first beam section near the first deflecting mirror on the reflecting side thereof. In other embodiments the first deflecting mirror is arranged between the first and the third section of the optical axis such that the first section of the radiation beam passes by the backside of the first deflecting mirror towards the concave mirror, and radiation reflected by the concave mirror towards the image surface does not cross the first section of the radiation beam. Various variants of projection objectives according to this general folding geometry are disclosed, for example, in U.S. Pat. No. 6,995,833 B2, US 2006/0082904 A1, or US 2006/0098298 A1.

In the case of reducing optical imaging, in particular of projection lithography, the image side numerical aperture NA is limited by the refractive index of the surrounding medium in image space. In immersion lithography the theoretically possible numerical aperture NA is limited by the refractive index of the immersion medium. The immersion medium can be a liquid or a solid. Solid immersion is also spoken of in the latter case.

However, for practical reasons the aperture should not come arbitrarily close to the refractive index of the last medium (i.e. the medium closest to the image), since the propagation angles then become very large relative to the optical axis. It has proven to be practical for the numerical aperture not to exceed substantially approximately 95% of the refractive index of the last medium of the image side. This corresponds to maximum propagation angles of approximately 72° relative to the optical axis. For 193 nm, this corresponds to a numerical aperture of NA=1.35 in the case of water (n_{H2O}=1.43) as immersion medium.

With liquids whose refractive index is higher than that of the material of the last lens, or in the case of solid immersion, the material of the last lens element (i.e. the last optical element of the projection objective adjacent to the image) acts as a limitation if the design of the last end surface (exit surface of the projection objective) is to be planar or only weakly curved. The planar design is advantageous, for example, for measuring the distance between wafer and objective, for hydrodynamic behaviour of the immersion medium between the wafer to be exposed and the last objective surface, and for their cleaning. The last end surface must be of planar design for solid immersion, in particular, in order to expose the wafer, which is likewise planar.

For DUV (operating wavelength of 248 nm or 193 nm), the materials normally used for the last lens are fused silica (synthetic quartz glass, SiO₂) with a refractive index of n_{SiO2}=1.56 at 193 nm or CaF₂ with a refractive index of n_{CaF2}=1.50 at 193 nm. The synthetic quartz glass material will also be referred to simply as “quartz” in the following. Because of the high radiation load in the last lens elements, at 193 nm calcium fluoride may be preferred for the last lens, in particular, since synthetic quartz glass may be damaged in the long term by the radiation load. This results in a numerical aperture of approximately 1.425 (95% of n=1.5) which can be achieved. Using quartz glass may allow numerical apertures of 1.48 (corresponding to approximately 95% of the refractive index of quartz at 193 nm). The relationships are similar at 248 nm.

The projection objective according to the above aspect of the invention has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength. In this case, the image-side numerical aperture NA may be extended close to the refractive index of the high-index material in certain cases. The high-index material may have a very high refractive index, for example n≧1.8 and/or n≧2.0 or higher.

Very high image-side NA may be obtained. The image-side NA may be higher than NA=1.35. In some embodiments the image-side NA is equal to or greater than 1.40, or equal to or greater than 1.45, or equal to or greater than 1.50. The image-side NA may be 1.55 or higher, which provides potential for highest resolutions in the order of R=35 nm or below at a nominal operating wavelength λ=193 nm.

Embodiments are configured to be operated with operating wavelengths in the deep ultraviolet (DUV) region, and the high-index material is transparent for ultraviolet radiation having a wavelength λ<260 nm, such as about 248 nm, or about 193 nm.

The high-index material may be chosen, for example, from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

The immersion lens group may be a monolithic plano-convex lens made of the high-index material. In other embodiments, the immersion lens group includes at least two optical elements in optical contact with each other along a splitting interface, where at least one of the optical elements forming the immersion lens group consists of a high-index material with refractive index n≧1.6. Further degrees of freedom for the design may be obtained by using such a plano-convex composite immersion lens group. The optical contact may be obtained by providing a physical contact at the mutually facing surfaces, e.g. by wringing. Cementing is an alternative. Another alternative is to provide a narrow gap between the facing surfaces, where the gap may be filled with air or another gas, or with an immersion liquid. The splitting surface may be planar or curved, for example concave towards the image-side. Composite piano-convex immersion lens groups are disclosed, for example, in US 2006/0012885 A1 filed by the applicant. The disclosure of this document is incorporated herein by reference.

The immersion lens group may form a last lens group closest to the image surface such that an exit side of the immersion lens group is directly adjacent to the image surface with no optical element in between. In other embodiments a plane parallel plate immersed on both sides in the immersion liquid may be arranged between the immersion lens group and the image plane, such as shown, for example, in WO 2006/013734.

In some embodiments a first field lens with a positive refractive power is arranged optically between the first intermediate image and the concave mirror. The first field lens may be positioned in a region optically close to the first intermediate image where the chief ray height of the imaging is large in comparison to the marginal ray height.

The first field lens may be arranged geometrically between the concave mirror and the first deflecting mirror in a region through which the beam passes twice in such a manner that a first lens area of the first field lens is arranged in the beam path between the object plane and the concave mirror, and a second lens area of the first field lens is arranged in the beam path between the concave mirror and the image surface. Typically the first and second lens areas overlap substantially. A double pass field lens may act very effectively as it is used twice in opposite directions by the radiation passing from the object surface to the image surface.

The first field lens may be arranged in a double pass region between the first intermediate image and the concave mirror. Positive refractive power between an upstream intermediate image and the concave mirror may reduce the numerical aperture in the part upstream of the concave mirror group and increases the geometrical distance from the folding mirrors to the concave mirror group, thereby facilitating installation and mounting

The expression “field lens” is used synonymously with the term “field lens group” and encompasses an individual lens or a lens group with at least two individual lenses. The expression takes account of the fact that the function of a lens can also be carried out by two or more lenses (splitting of lenses).

The expression “intermediate image” describes the area where adjacent aperture rays (rays running from one object field point to different locations in the entrance pupil) cross each other. In general this is an axial region which entends at least between a paraxial intermediate image and a marginal ray intermediate image. Depending on the correction state of the intermediate image, this area may extend over a certain axial range in which case, by way of example, the paraxial intermediate image may be located in the light path upstream or downstream of the marginal ray intermediate image, depending on the spherical aberration (overcorrection or undercorrection). For off-axis field points field aberrations, such as coma and astigmatism, may also influence the axial extension of an intermediate image. The paraxial intermediate image and the marginal ray intermediate image may also essentially coincide.

For the purposes of this application, an optical element A, for example a field lens, is located “between” an intermediate image and another optical element B when at least a portion of the optical element A is located between the (generally axially extended) intermediate image and the optical element B. The intermediate image may thus also partially extend beyond an optical surface which, for example, may be advantageous for correction purposes.

In some embodiments the first field lens is a single lens. Benefits of a double-pass positive field lens may thereby be obtained in an axially compact second objective part. The first field lens may be spherical on both surfaces. In some embodiments, at least one surface is aspheric. In some embodiments, the single first field lens is a positive meniscus lens convex towards the first intermediate image and/or the first deflecting mirror, allowing to arrange the positive optical power very close to the first and/or the second intermediate image.

The first field lens may be arranged such that it is arranged not only in the optical vicinity of an intermediate image plane which is located in the beam path upstream of the concave mirror, but also in the optical vicinity of an intermediate image plane which is located in the beam path down-stream from the concave mirror. This results in an arrangement close to the field with respect to two successive field surfaces, so that a powerful correction effect can be achieved at two points in the beam path.

In some embodiments a single-pass second field lens with a positive refractive power is arranged geometrically between the first folding mirror and the second folding mirror. The single-pass field lens may be positioned in a region optically close to the second intermediate image. This region close to a field surface may be distinguished in particular by the chief ray height CRH of the imaging being large in comparison to the marginal ray height MRH.

The second field lens may be arranged in the third objective part, i.e. optically downstream of the second intermediate image, for example as a first optical element of the third objective part in radiation propagation direction.

The enlargement of numerical aperture which is desired in order to achieve very high resolutions frequently leads in conventional systems to an increase in size of the intermediate images, which may lead to a significant increase in the diameter of the optical components which are located near the intermediate images. Providing a field lens counteracts this effect, mainly for lenses optically upstream of the first intermediate image and optically downstream of the second intermediate image. As a result, a more compact design with reduced system dimensions may be obtained.

In some embodiments the second field lens is a single lens. The single lens may have at least one aspherical lens surface such that a single aspherical positive lens in arranged in between the folding mirrors in certain embodiments. The effectiveness of the correction can be assisted by designing at least one surface of the field lens as an aspherical surface. In some embodiments the aspherical surface may be the lens surface of the second field lens which faces the second intermediate image.

Providing at least one aspheric surface may be beneficial in terms of correction of pupil aberrations. When only a single second field lens is provided, mounting is facilitated and the overall mechanical construction may be simplified and more stable than in cases where more than one lens is provided in the region between the deflecting mirrors.

In some embodiments a geometrical distance between the object surface and the first deflecting mirror is significantly larger than in the prior art. Typically, the first intermediate image is located geometrically near the first deflecting mirror to allow imaging with high numerical aperture without vignetting. Therefore, a large geometrical distance between the object surface and the first deflecting mirror mostly corresponds to an increased length of the first objective part in its axial direction. As a consequence, a geometrical distance between the object surface and the second section of the optical axis (defined between the deflecting mirrors) may be significantly larger than the geometrical distance between the second section of the optical axis and a plane through the image surface. In some embodiments L is a geometrical distance between a plane through the object surface and a plane through the image surface; L1 is a geometrical distance between a plane through the object surface and an intersection point of the first section of the optical axis and a plane defined by the first deflecting mirror; L2 is a geometrical distance between the intersection point of the first section of the optical axis and the plane defined by the first deflecting mirror, and a plane through the image surface such that L=L1+L2; and the condition 1.06<A=L1/L2 holds. In some embodiments A≧1.2 and/or A≧1.25 and/or A≧1.3 and/or A≧1.35, for example.

Increasing the parameter A leads to a decrease of the system length from the second intermediate image to the image surface while keeping a sufficiently large separation between the two vertical barrels, the space needed e.g. for lens mounting. The decrease of the system length from the second intermediate image to the image surface may also lead to more compact system with respect to lens diameters.

In some embodiments, the overall length of the third objective part between second intermediate image and image surface is relatively small when compared to prior art systems. Specifically, in some embodiments the third objective part has a lens with a maximum lens diameter arranged close to the third pupil surface, lens diameters increase monotonically between the second intermediate image and the lens with maximum diameter and decrease monotonically between the lens with maximum diameter and the image surface. With other words, those embodiments do not have a pronounced local minimum in beam diameter, as typically found as “waist” in conventional systems. More compact designs are made possible, requiring less lens material.

The previous and other properties can be seen not only in the claims but also in the description and the drawings, wherein individual characteristics may be used either alone or in sub-combinations as an embodiment of the invention and in other areas and may individually represent advantageous and patentable embodiments.

### BRIEF DESCRIPTION OF THE DRAWINGS

FIG. 1 shows a schematic drawing of an embodiment of a projection exposure apparatus for microlithography having an illumination system and a projection objective;

FIG. 2 shows a first embodiment of a catadioptric projection objective;

FIG. 3 shows a schematic representation of representative geometric dimensions;

FIG. 4 shows a second embodiment of a catadioptric projection objective;

FIG. 5 shows a third embodiment of a catadioptric projection objective;

FIG. 6 shows a fourth embodiment of a catadioptric projection objective;

FIG. 7 shows a fifth embodiment of a catadioptric projection objective;

### DETAILED DESCRIPTION OF THE PREFERRED EMBODIMENTS

In the following description of preferred embodiments, the term “optical axis” refers to a straight line or a sequence of a straight-line segments passing through the centers of curvature of optical elements. The optical axis can be folded by folding mirrors (deflecting mirrors) such that angles are included between subsequent straight-line segments of the optical axis. In the examples presented below, the object is a mask (reticle) bearing the pattern of a layer of an integrated circuit or some other pattern, for example, a grating pattern. The image of the object is projected onto a wafer serving as a substrate that is coated with a layer of photoresist, although other types of substrates, such as components of liquid-crystal displays or substrates for optical gratings, are also feasible.

Where tables are provided to disclose the specification of a design shown in a figure, the table or tables are designated by the same numbers as the respective figures. Corresponding features in the figures are designated with like or identical reference identifications to facilitate understanding. Where lenses are designated, an identification L3-2 denotes the second lens in the third objective part (when viewed in the radiation propagation direction).

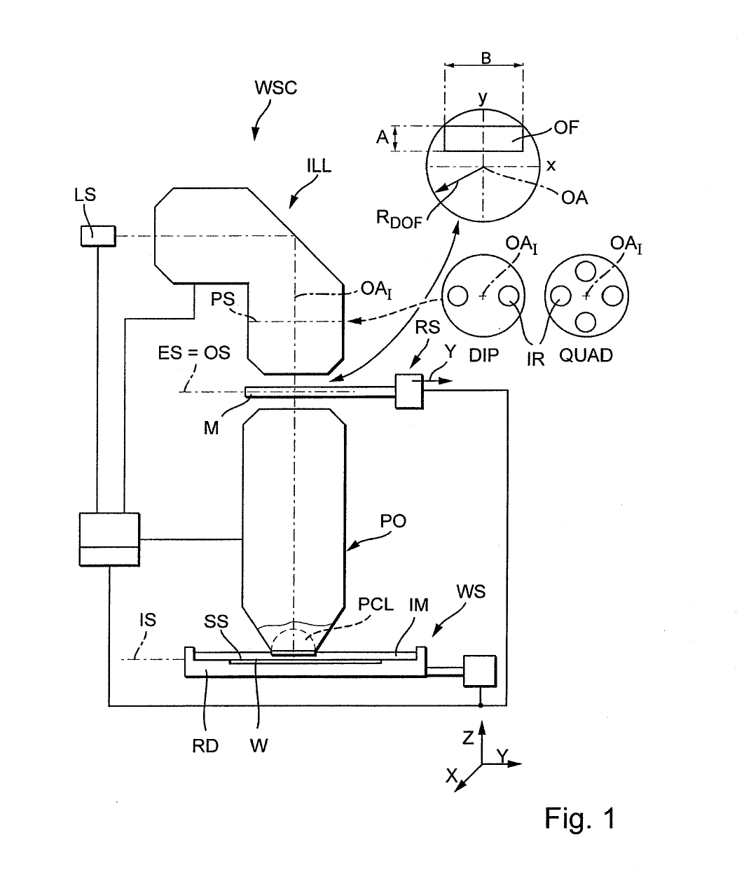

FIG. 1 shows schematically a microlithographic projection exposure system in the form of a wafer scanner WSC, which is provided for fabricating large scale integrated semiconductor components by means of immersion lithography in a step-and-scan mode. The projection exposure system comprises an Excimer laser as light source LS having an operating wavelength of 193 nm. Other operating wavelengths, for example 157 nm or 248 nm, are possible. A downstream illumination system ILL generates, in its exit surface ES, a large, sharply delimited, homogeneously illuminated illumination field arranged off-axis with respect to the optical axis of the projection objective PO (which is coaxial with optical axis OA₁ of the illumination system in embodiments) and adapted to the telecentric requirements of the downstream catadioptric projection objective PO. Specifically, the exit pupil of the illumination system coincides with the entrance pupil of the projection objective for all field points. The multi-axis projection objective is shown schematically only to to facilitate illustration. The illumination system ILL has devices for selecting the illumination mode and, in the example, can be changed over between conventional on-axis illumination with a variable degree of coherence, and off-axis illumination, particularly annular illumination (having a ring shaped illuminated area in a pupil surface of the illumination system) and dipole or quadrupole illumination.

A device RS for holding and manipulating a mask M is arranged between the exit-side last optical element of the illumination system and the entrance of the projection objective such that a pattern—arranged on or provided by the mask—of a specific layer of the semiconductor component to be produced lies in the planar object surface OS (object plane) of the projection objective, said object plane coinciding with the exit plane EX of the illumination system. The device RS—usually referred to as “reticle stage”—for holding and manipulating the mask contains a scanner drive enabling the mask to be moved parallel to the object surface OS of the projection objective or perpendicular to the optical axis (z direction) of projection objective and illumination system in a scanning direction (y-direction) for scanning operation.

The size and shape of the illumination field provided by the illumination system determines the size and shape of the effective object field OF of the projection objective actually used for projecting an image of a pattern on a mask in the image surface of the projection objective. The slit-shaped effective object field has a height A parallel to the scanning direction and a width B>A perpendicular to the scanning direction and may be rectangular (as shown in the inset figure) or arcuate (ring field). An aspect ratio B/A may be in a range from B/A=2 to B/A=10, for example. The same applies for the illumination field. A circle with minimum radius R_{DOF} around the effective object field and centred about the optical axis OA of the projection objective indicates the design object field including field points sufficiently corrected for aberrations to allow imaging with a specified performance and free of vignetting. The effective object field includes a subset of those field points.

The reduction projection objective PO is telecentric at the object and image side and designed to image an image of a pattern provided by the mask with a reduced scale of 4:1 onto a wafer W coated with a photoresist layer. Other reduction scales, e.g. 5:1 or 8:1 are possible. The wafer W serving as a light-sensitive substrate is arranged in such a way that the planar substrate surface SS with the photoresist layer essentially coincides with the planar image surface IS of the projection objective. The wafer is held by a device WS (wafer stage) comprising a scanner drive in order to move the wafer synchronously with the mask M in parallel with the latter, and with reduced speed corresponding to the reduction ratio of the projection objective. The device WS also comprises manipulators in order to move the wafer both in the Z direction parallel to the optical axis OA and in the X and Y directions perpendicular to said axis. A tilting device having at least one tilting axis running perpendicular to the optical axis is integrated.

The device WS provided for holding the wafer W (wafer stage) is constructed for use in immersion lithography. It comprises a receptacle device RD, which can be moved by a scanner drive and the bottom of which has a flat recess for receiving the wafer W. A peripheral edge forms a flat, upwardly open, liquid-tight receptacle for a liquid immersion medium IM, which can be introduced into the receptacle and discharged from the latter by means of devices that are not shown. The height of the edge is dimensioned in such a way that the immersion medium that has been filled in can completely cover the surface SS of the wafer W and the exit-side end region of the projection objective PO can dip into the immersion liquid given a correctly set operating distance between objective exit and wafer surface.

The projection objective PO has an immersion lens group formed by a plano-convex lens PCL, which is the last optical element nearest to the image surface IS. The planar exit surface of said lens is the last optical surface of the projection objective PO. During operation of the projection exposure system, the exit surface of the plano-convex lens PCL is partly or completely immersed in the immersion liquid IM and is wetted by the latter. In the exemplary case the immersion liquid has a refractive index n₁≈1.65 at 193 nm. The convex entry surface of piano-convex lens PCL is adjacent to a gas filling the space between this lens and a lens immediately upstream thereof on the object-side. The plano-convex lens forms a monolithic immersion lens group allowing the projection objective to operate at NA>1 in an immersion operation.

In this application, the term “immersion lens group” is used for a single lens or a lens group including at least two cooperating optical elements providing a convex object-side entry surface bounding at a gas or vacuum and an image-side exit surface in contact with an immersion liquid in operation. The exit surface may be essentially planar. The immersion lens group guides the rays of the radiation beam from gas (or vacuum) into the immersion liquid.

Various different illumination settings may be set with the illumination system ILL. For example, where the pattern of the mask to be projected on the wafer essentially consists of parallel lines running in one direction, a dipole setting DIP (see left inset figure) may be utilized to increase resolution and depth of focus. To this end, adjustable optical elements in the illumination system are adjusted to obtain, in a pupil surface PS of the illumination system ILL, an intensity distribution characterized by two locally concentrated illuminated regions IR of large light intensity at diametrically opposed positions outside the optical axis OA and little or no light intensity on the optical axis. A similar inhomogeneous intensity distribution is obtained in pupil surfaces of the projection objective optically conjugate to the pupil surface of the illumination system.

The illumination setting may be changed to obtain, for example, conventional illumination (rotational symmetry around the optical axis) or quadrupole illumination (four-fold radial symmetry around the optical axis, see right hand side inset figure QUAD with four off-axis illuminated regions IR).

Illumination systems capable of optionally providing the described off-axis polar illumination modes are described, for example, in U.S. Pat. No. 6,252,647 B1 or in applicant's patent application US 2006/005026 A1, the disclosure of which is incorporated herein by reference.

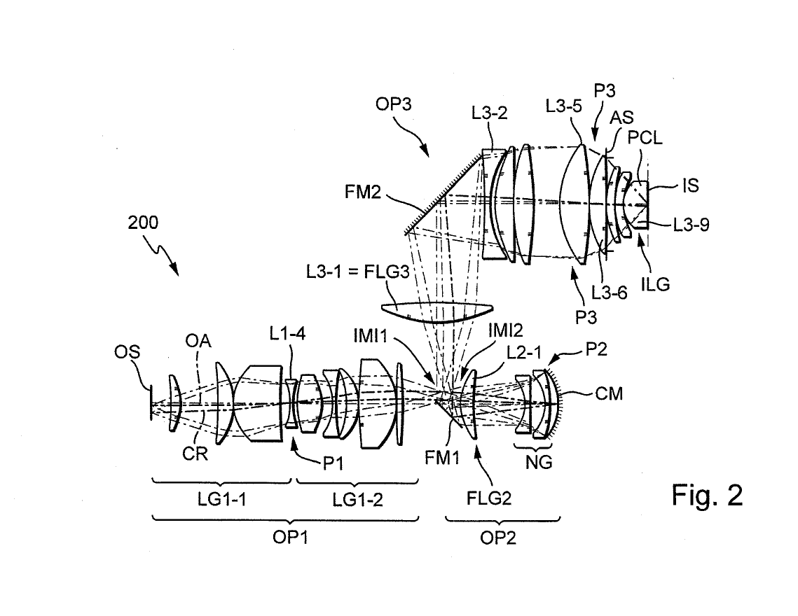

FIG. 2 shows a catadioptric projection objective 200 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1750 mm. The radius R_{DOF} of the design object field, also denoted object field height OBH, is 61 mm. The specification is given in tables 2, 2A.

Projection objective 200 has a telecentric image space and is designed to project an image of a pattern on a reticle arranged in the planar object surface OS (object plane) into the planar image surface IS (image plane) on a reduced scale while creating exactly two real intermediate images IMI1, IMI2. The rectangular effective object field OF and image field IF are off-axis, i.e. entirely outside the optical axis OA. A first refractive objective part OP1 is designed for imaging the pattern provided in the object surface into the first intermediate image IMI1. A second, catadioptric (refractive/reflective) objective part OP2 images the first intermediate image IMI1 into the second intermediate image IMI2 at a magnification close to 1:(−1). A third, refractive objective part OP3 images the second intermediate image IMI2 onto the image surface IS with a strong reduction ratio.

Projection objective 200 is an example of a “concatenated” projection objective having a plurality of cascaded objective parts which are each configured as imaging systems and are linked via intermediate images, the image (intermediate image) generated by a preceding imaging system in the radiation path serving as object for the succeeding imaging system in the radiation path. The succeeding imaging system can generate a further intermediate image (as in the case of the second objective part OP2) or forms the last imaging system of the projection objective, which generates the “final” image field in the image plane of the projection objective (like the third objective part OP3). Systems of the type shown in FIG. 2 are sometimes referred to as R—C—R system, where “R” denotes a refractive (dioptric) imaging system and “C” denotes a catadioptric (or catoptric) imaging system.

The path of a projection CR of a chief ray of an outer field point of the off-axis object field OF onto the meridional plane (drawing plane) is drawn bold in FIG. 2 in order to facilitate following the beam path of the projection beam. For the purpose of this application, the term “chief ray” (also known as principal ray) denotes a ray running from an outermost field point (farthest away from the optical axis) of the effectively used object field OF to the center of the entrance pupil. Using an off axis rectangular object field the chief ray of the objective may originate at the outermost field corner. Thus, only the projection of the chief ray onto the meridional plane may be displayed in the figures but not its real height. Due to the rotational symmetry of the system the chief ray may be chosen from an equivalent field point in the meridional plane. This equivalent chief ray may not contribute to the imaging when an off axis object field with fold mirrors or other surfaces acting as baffles are used. In projection objectives being essentially telecentric on the object side, the chief ray emanates from the object surface parallel or at a very small angle with respect to the optical axis. The imaging process is further characterized by the trajectory of marginal rays. A “marginal ray” as used herein is a ray running from an axial object field point (field point on the optical axis) to the edge of an aperture stop. That marginal ray may not contribute to image formation due to vignetting when an off-axis effective object field with fold mirrors or other surfaces acting as baffles is used. The chief ray and marginal ray are chosen to characterize optical properties of the projection objectives. The radial distance between such selected rays and the optical axis at a given axial position are denoted as “chief ray height” (CRH) and “marginal ray height” (MRH), respectively. The angle included between the chief ray and the optical axis is the chief ray angle CRA. The angle included between the marginal ray and the optical axis is the marginal ray angle MRA.

The projection objective is essentially telecentric in image space, i.e. the exit pupil is located essentially at infinity. This determines the position of the pupil surfaces in the subsystems being the conjugate planes to the exit pupil at infinity. The object space may be essentially telecentric as well, thus providing an entrance pupil essentially at infinity.

Three mutually conjugated pupil surfaces P1, P2 and P3 are formed at positions where the chief ray intersects the optical axis. A first pupil surface P1 is formed in the first objective part between object surface and first intermediate image, a second pupil surface P2 is formed in the second objective part between first and second intermediate image, and a third pupil surface P3 is formed in the third objective part between second intermediate image and the image surface IS.

The second objective part OP2 includes a single concave mirror CM situated in the vicinity of the second pupil surface P2 at CRH/MRH≦0.5. The projection objective includes two negative meniscus lenses forming a negative group NG immediately in front of the concave mirror CM and coaxial with the concave mirror and passed twice by radiation on its way from first objective part towards the concave mirror, and from the concave mirror towards the first folding mirror FM1. A combination of a concave mirror arranged at or optically close to a pupil surface and a negative group comprising at least one negative lens arranged in front of the concave mirror on a reflecting side thereof in a double pass region such that radiation passes at least twice in opposite directions through the negative group is sometimes referred to as “Schupmann achromat”. This group contributes significantly to correction of chromatic aberrations, particularly axial chromatic aberration. Correction of Petzval sum is predominantly influenced by the curvature of concave mirror CM.

The concave mirror CM is arranged coaxially with the lenses of the first objective part OP1 and receives light from the object surface or the first intermediate image, respectively, without intermediate deflection by a mirror. A first planar folding mirror FM1 is arranged geometrically close to the first intermediate image at an angle 45° relative to the optical axis OA such that it reflects radiation reflected by the concave mirror towards a second folding mirror FM2 arranged downstream of the first folding mirror. The first folding mirror FM1 is arranged on the same side of the optical axis as the off-axis object field OF, which is on the opposite side to the first intermediate image. The first intermediate image IMI1 is formed very close to the front edge of the first folding mirror FM1 facing the optical axis OA such that the radiation beam passes at a small distance from the front edge without causing vignetting. The second intermediate image IMI2 is formed immediately downstream of the first folding mirror FM1 at a small distance therefrom, optically between the first and second folding mirrors FM1, FM2, and geometrically overlapping with the first intermediate image IMI1. A double pass region where the radiation passes twice in opposite directions is formed geometrically between the first deflecting mirror FM1 and the concave mirror CM, and optically between the first intermediate image IMI1 and the first folding mirror FM1. The second folding mirror FM2, having a planar mirror surface aligned at right angles to the planar mirror surface of the first folding mirror, reflects the radiation coming from the first folding mirror FM1 in the direction of the image surface IS, which is aligned parallel to the object surface OS.

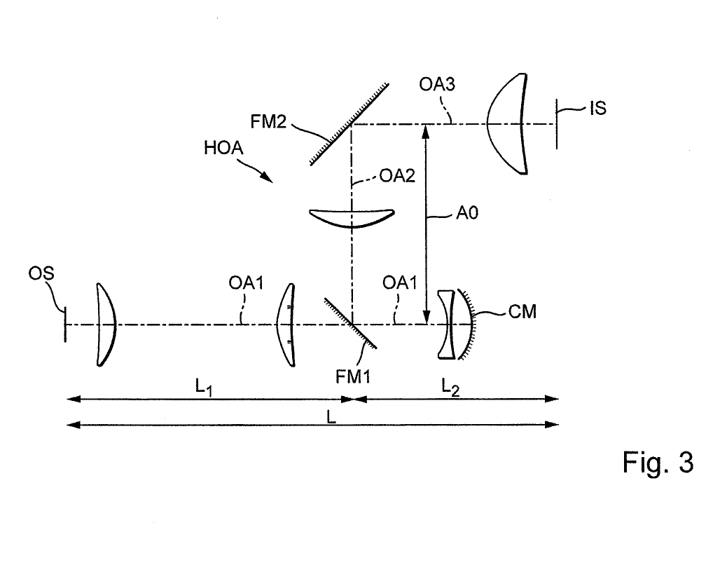

Characteristic geometrical dimensions of the general layout are further explained in connection with FIG. 3. The first section OA1 of the optical axis is defined between the object surface OS and the concave mirror CM. A second section OA2 of the optical axis is defined transverse to the first section of the optical axis between the first folding mirror FM1 and the second folding mirror FM2. A third section OA3 of the optical axis is defined between the second reflecting mirror FM2 and the image surface IS. Due to the mutually perpendicular orientation of the planar reflecting surface of first and second folding mirrors FM1, FM2, the third section OA3 of the optical axis is parallel to the first section OA1 of the optical axis. An axis offset AO corresponding to the geometrical length of the second section OA2 of the optical axis is defined therebetween. The axis offset must be chosen sufficiently large in order to allow for a stable mounting technology of the optical elements in the second and third objective parts.

The optical axis is folded by 90° at the first and second folding mirrors FM1, FM2 due to the 45° inclination of these folding mirrors. However, inclination angles deviating significantly from 45°, for example by about up to 5° or up to 10°, may be used in embodiments such that the second section OA2 of the optical axis includes non-rectangular angles with the other sections OA1, OA3 (see, for example, U.S. Pat. No. 6,995,833 B2, FIG. 2). When the projection objective is installed in a projection exposure apparatus, the first and third sections of the optical axis are typically oriented in the vertical direction such that the second section OA2 is aligned in a horizontal direction or at a small angle from the horizontal direction. Therefore, the transverse section defined by the second section OA2 of the optical axis is sometimes denoted as “horizontal optical axis” HOA. The geometrical layout may be defined by a first length L1 being a geometrical distance between a plane through the object surface and an intersection point of the first section OA1 of the optical axis and the plane defined by the first deflecting mirror, and a second length L2 being a geometrical distance between the intersection point of the first section of the optical axis and the plane defined by the first deflecting mirror, and the plane through the image surface IS such that L=L1+L2. In general, a length ratio A=L1/L2 may be used as a measure of the axial length of the first objective part OP1 relative to the parts of the projection objective on the image-side. Where the horizontal arm is perpendicular to the “vertical arms”, L2 corresponds to the geometrical length of the third section OA3 of the optical axis.

Details of the embodiment of FIG. 2 are now described in more detail. The first objective part OP1 includes 9 lenses forming a first lens group LG1-1 with positive refractive power and a second lens group LG1-2 with positive refractive power, the pupil surface P1 being disposed between the two lens groups. Two or three positive lenses of the second lens group LG1-2 closest to the first intermediate image may be considered as forming a first field lens group. A biconvex negative lens L1-4 is situated close to or at the first pupil surface. The first objective part defines the position, size, shape and correction status of the first intermediate image IMI1 formed close to the inner edge of first folding mirror FM1.

A single positive meniscus lens L2-1 is arranged in the double-pass region geometrically close to the first folding mirror FM1 optically immediately downstream of first intermediate image IMI1 and optically close to the first intermediate image in a region where the chief ray height is larger than the marginal ray height, thereby acting as positive field lens group FLG2. The convex lens surface facing the first intermediate image is spherical, the slightly concave lens surface facing the concave mirror is aspheric. Positive field lens L2-1 is effective to converge incident radiation towards the concave mirror CM, and radiation reflected from the concave mirror is converged towards the second intermediate image IMI2, which is formed downstream of field lens group FLG2 and the first folding mirror FM1. Therefore, first folding mirror FM2 is part of second objective part OP2.

A single biconvex positive lens L3-1 having an aspherical entry surface facing the second intermediate image IMI2 and the spherical exit surface facing the second folding mirror FM2 is arranged in a single pass region geometrically between the first and second folding mirrors FM1, FM2, respectively and forms the first (entry-side) lens of the third objective part OP3. This lens is arranged in a position where CRH>MRH and acts as a field lens. A single positive field lens in this region effectively contributes to pupil imaging from the second to the third pupil surface. At the same time, mounting of the field lens is simplified and a mechanically stable construction is made possible due to the fact that there is only one single lens between the folding mirrors. The free optical diameters of the lenses on the third objective part OP3 may be reduced, allowing to reduce the axis offset AO without impairing the mounting ability when compared to conventional systems. A biconcave negative lens L3-2 having a concave exit surface and a concave aspherical entry surface is arranged immediately down-stream of second folding mirror FM2 in a region of diverging radiation. Large angles of incidence generated at the concave exit surface contribute effectively to aberration correction and to correction of the sine condition at the image surface. Radiation diverges only slightly downstream of the concave exit side towards biconvex lens L3-5 forming the lens with the largest diameter in the third objective part. Positive lens L3-5 in conjunction with four consecutive positive lenses is effective to converge radiation towards the image surface IS.

A variable aperture stop AS is arranged at or close to the third pupil surface P3 in a region of convergent beam between the positive lens L3-6 and the image surface. It may be advantageous to construct the aperture stop such that it has an aperture stop edge determining the aperture stop diameter, where the axial position of the aperture edge with reference to the optical axis is varied as a function of the aperture stop diameter. This permits optimum adaptation of the effective aperture stop position to the beam path as a function of the aperture stop diameter. For example, the aperture stop may be configured as a spherical aperture stop in which the aperture stop edge can be moved along a spherical surface during adjustment of the aperture stop diameter. In particular, the aperture stop edge may be moved on a spherical surface which is concave to the image side when the aperture stop diameter is decreased. Alternatively, the aperture stop may be designed as a conical aperture stop in which the aperture stop edge can be moved on a lateral surface of the cone during adjustment of the aperture stop diameter. This can be achieved, for example, by providing a planar aperture stop and a device for axially displacing the planar aperture stop as the aperture diameter is varied.

The image-side end of the projection objective is formed by a piano-convex positive lens L3-9 (PCL) acting as an immersion lens group ILG to guide the radiation rays from a gas-filled space upstream of the convex entry surface of the plano-convex lens into the immersion liquid which fills the image-side working space between the planar exit surface of the piano-convex lens and the image surface during operation. Piano-convex lens L3-9 is made of luthetium aluminium garnet (LuAG), having a refractive index n≈2.14 at λ=193 nm. All other lenses are made of fused silica with n≈1.56 at λ=193 nm.

The embodiment may be characterized by a relatively long first objective part OP1, characterized by a first length L1 significantly larger than the second length L2 such that A=L1/L2=1.38. The overall length of the third objective part, measured along the folded optical axis OA2/OA3 between second intermediate image and image surface, may be kept relatively short, thereby decreasing the system length from the second intermediate image to the final image and therefore decreasing the diameters of the lenses in this objective part, particularly those lenses between the second folding mirror FM2 and the image surface. Material consumption may thereby be reduced. The third objective part has only nine lenses. A relatively short overall length of the third objective part OP3 may also be indicated by the absence of any local beam diameter constriction (waist) in the third objective part. Whereas conventional systems usually exhibit a pronounced waist in the third objective part, i.e. a region where the radiation beam diameter attains a local minimum between the second intermediate image and the image surface, there is no waist in the third objective part of this embodiment. Instead, the utilized (optically free) lens diameters of lenses in the third objective part increase monotonically from the second intermediate image to lens L3-5 having maximum lens diameter, and decrease monotonically between that lens and the image surface, thereby forming a single belly or bulge very effective to generate large image-side NA while the overall length and material consumption of the third objective part (focusing subsystem) remains moderate.

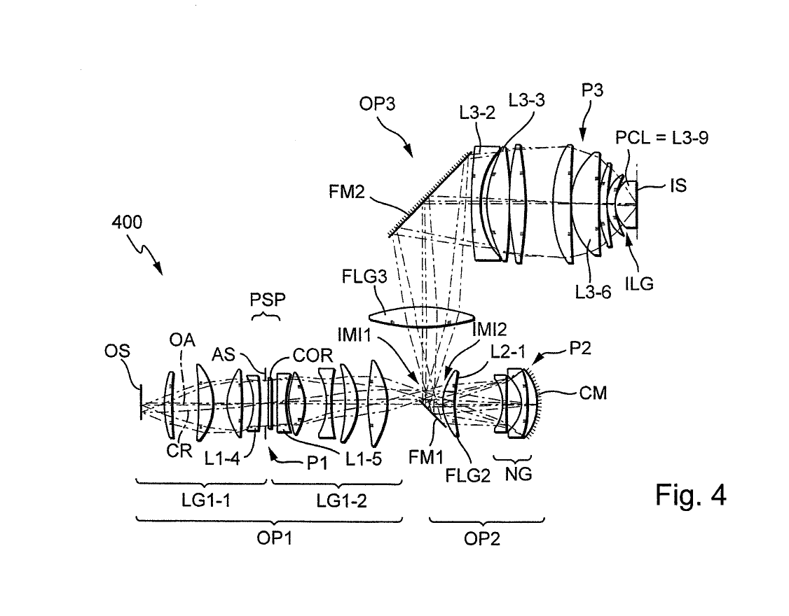

FIG. 4 shows a catadioptric projection objective 400 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1750 mm. The radius R_{DOF} of the design object field is 61 mm. The length ratio A=L1/L2=1.30. The specification is given in tables 4, 4A.

Some characterizing features are now discussed in relation to the embodiment of FIG. 2. In general, the sequence of objective parts, intermediate images and lens groups is similar to that embodiment. Therefore, reference is made to that description. Some differences are now discussed in more detail.

In the first objective part OP1, first positive lens group LG1-1 includes a negative meniscus lens L1-4 immediately upstream of first pupil surface P1. Second positive lens group LG1-2 includes a negative lens L1-5 being the first optical element with refractive power downstream of first pupil surface P1. A pupil space PSP having an axial extension of some 10 mm is formed between the facing surfaces of these negative lenses, the pupil space being free of lenses with refractive power. A variable aperture stop AS is positioned in the first objective part OP1 at the first pupil surface P1 within the pupil space PSP spaced apart from neighbouring lenses. The variable aperture stop AS may be configured as a planar aperture stop having a relatively simple construction. A variable aperture stop in the first objective part may also be provided in other embodiments discussed in this application.

A correcting element COR basically designed as a plane parallel plate inserted orthogonal to the optical axis is provided within the pupil space close to the first pupil surface P1 and the aperture stop AS. At least one surface of the correcting element may be shaped as an aspherical surface to obtain a desired spatial distribution of refractive power substantially deviating from a spatial distribution of refractive power of a spherical or a planar surface. The correcting element may be a permanent correcting element designed to correct residual aberrations in the projection objective during manufacturing (e.g. a correction asphere). In other embodiments, the correcting element is an exchangeable element. An exchanging device operatively coupled to the correcting element and configured to optionally insert one of a set of correcting elements into the beam path at the first pupil surface may be provided such that the projection objective may be operated with at least two alternative correcting elements having different optical effects during operation. Further details regarding embodiments and use of correcting elements suitable for that purpose may be taken from European patent application no. 06024790.5 filed on Nov. 30, 2006. The disclosure of this document is incorporated herein by reference.

The third objective part includes the single, positive aspheric field lens group FLG3 between the first and second folding mirrors FM1, FM2 optically close to the second intermediate image IMI2. A negative meniscus lens L3-2 with concave exit surface providing large angles of incidence is arranged immediately downstream of second folding mirror FM2. All lenses L3-3 to L3-9 downstream of L3-2 (L3-9 corresponding to piano-convex lens PCL forming the immersion lens group ILG) have positive refractive power, thereby allowing to concentrate power required for generating the high-image side NA in an axially compact arrangement. Plano-convex lens PCL forming the last optical element of the projection objective immediately adjacent to the image surface is made of ceramic magnesium aluminium oxide (MgAlO₄), also denoted as spinel, having a refractive index n≈1.92 at λ=193 nm. All other lenses are made of fused silica with n≈1.56 at λ=193 nm.

The axial distance between the exit surface of the last negative lens L3-2 upstream of the image surface IS and the image surface may be denoted as L_{neg}. The condition L_{neg}>L2/2 is fulfilled. Only positive lenses (no negative lens, particularly no negative meniscus lenses) are provided in an axially extended region with length L_{neg} upstream of the image surface, which contributes to keep the axial extension of the further objective part down-stream of second folding mirror FM2 relatively short and the lens diameter relatively small.

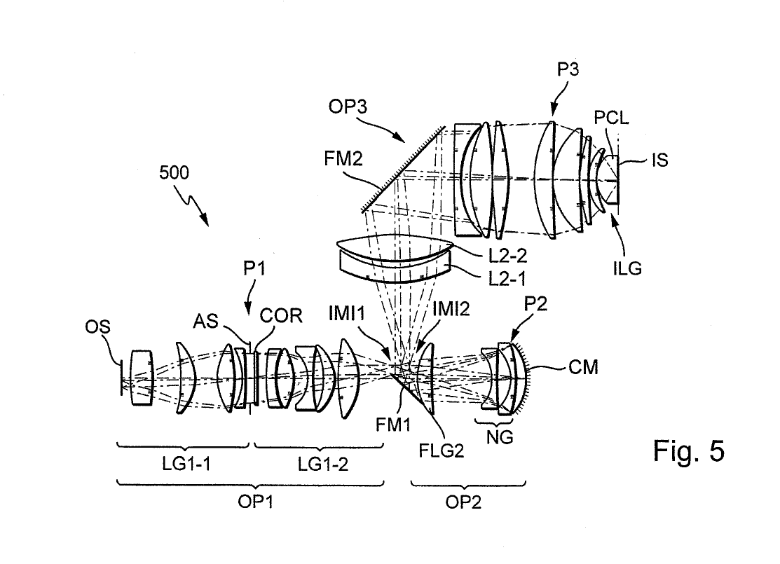

FIG. 5 shows a catadioptric projection objective 500 designed for a nominal UV-operating wavelength λ=193 nm, with a general layout similar to the embodiment of FIG. 4. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1750 mm. The radius R_{DOF} of the design object field is 61 mm. The length ratio A=L1/L2=1.24. The specification is given in tables 5, 5A.

In this embodiment, a lens doublet formed by a negative meniscus lens L2-1 having aspheric entry surface and concave image-side exit surface and a subsequent biconvex positive lens L2-2 is arranged in the single pass region between the first and second folding mirrors FM1, FM2 downstream of second intermediate image IMI2. This lens group may contribute to aberration correction. Particularly, correction of the sine condition at the image surface may be facilitated. Typically, a concave surface directed towards the image surface arranged in the region of diverging beam at a large distance upstream of the image surface may contribute to correction of the sine condition. In a compact third objective part, a preferred position of such image-side concave surface may be at or close to the position of the second folding mirror FM2. Since a corresponding lens cannot be mounted at the position of second folding mirror FM2, the image-side concave surface within the lens doublet L2-1, L2-2 may provide some of the correcting action contributing to correcting the sine condition.

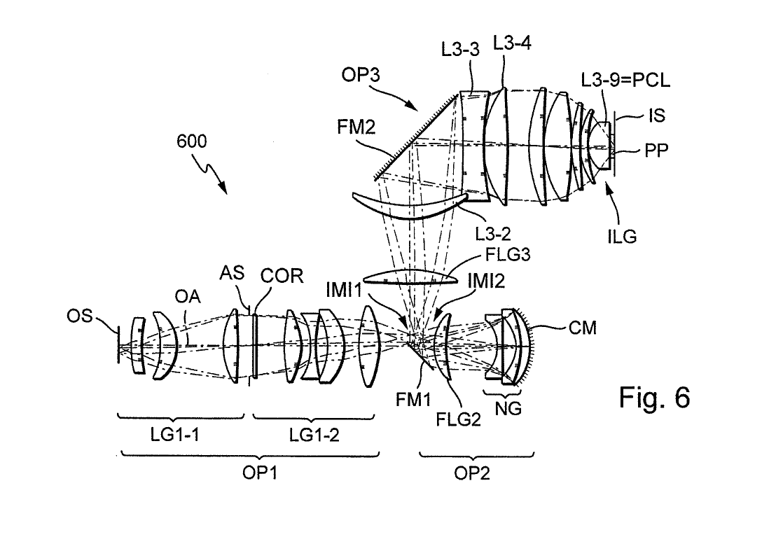

FIG. 6 shows a catadioptric projection objective 600 designed for a nominal UV-operating wavelength λ=193 nm. An image-side numerical aperture NA=1.55 is obtained at a reducing magnification 4:1 (β=−0.25) in a rectangular off-axis image field with size 26 mm×5.5 mm. The total track length L (geometrical distance between object surface and image surface) is 1750 mm. The radius R_{DOF} of the design object field is 61 mm. The length ratio A=L1/L2=1.43. The specification is given in tables 6, 6A.

Projection objective 600 may be considered as a variant of projection objective 500 with differences mainly in the construction of the third objective part. The third objective part includes, in the horizontal arm between folding mirrors FM1, FM2, an aspheric positive field lens group FLG3 formed by a single biconvex lens, and a positive meniscus lens L3-2 relatively close to second folding mirror FM2 and providing a concave exit surface. A biaspheric lens L3-3 with negative refractive power and generally concave entry and exit surfaces is provided immediately downstream of second folding mirror FM2. In this embodiment, the maximum incidence angles on the concave exit sides of L3-2 and L3-3 are smaller than in the embodiment of FIG. 5, thereby facilitating the design of effective antireflection coatings for these lens surfaces. Aberration correction is supported by the double aspheric lens L3-3 providing a complex radial distribution of refractive power upstream of the subsequent positive lenses L3-4 to L3-9, the last lens L3-9 being a plano-convex lens PCL.

In the embodiments discussed above, the plano-convex lens PCL with convex entry side and planar exit side forms the last optical element of the projection objective, the planar exit side of piano-convex lens forming the lens surface immediately adjacent to the image surface, i.e. with no optical element in between. In the embodiment of FIG. 6 a plane parallel plate PP immersed on both sides in the immersion liquid during operation is arranged between the plano-convex lens PCL and the image plane. Similar groups of optical elements may be found, for example, in WO 2006/013734.

Embodiments may be used at different operating wavelengths depending on requirements. While the above embodiments are designed for projection exposure system having a nominal operating wavelength of λ=193 nm (provided by an ArF₂ excimer laser light source) embodiments may be optimized for other wavelengths in the DUV region.

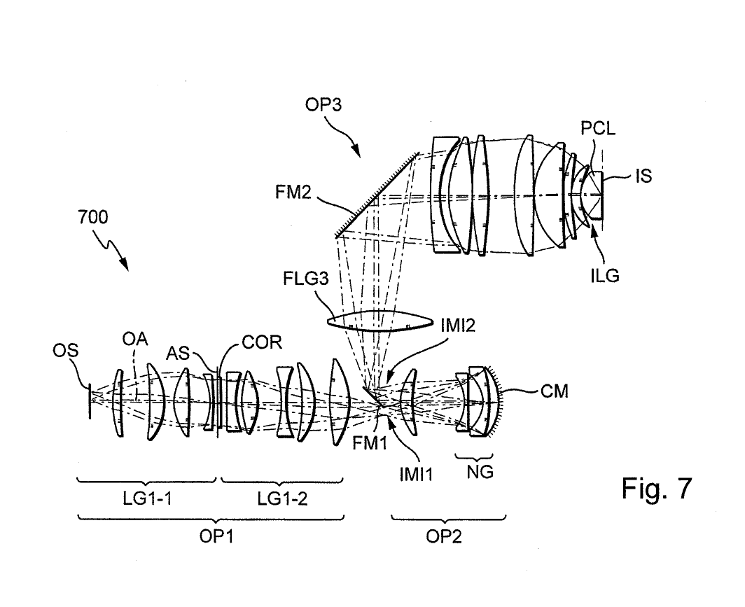

Projection objective 700 shown in FIG. 7 is designed for operating wavelength λ=248 nm provided by a KrF excimer laser light source. An image-side numerical aperture NA=1.48 is obtained at a reducing magnification 4:1 (β=−0.25) in a rectangular off-axis image field with size 26 mm×5.5 mm. The image-side NA is reduced in comparison to the previous embodiments due to the smaller refractive index of the immersion liquid n=1.58 an 248 nm. The total track length L (geometrical distance between object surface and image surface) is 1750 mm. The radius R_{DOF} of the design object field is 61 mm. The length ratio A=L1/L2=1.30. The specification is given in tables 7, 7A.

The exemplary embodiment shows that image-side NA can be increased beyond the conventional limits when a high-index material is used in the immersion lens group. Piano-convex lens PCL forming the last optical element of the projection objective immediately adjacent to the image surface is made of ceramic magnesium aluminium oxide (MgAlO₄), also denoted as spinel, having an estimated refractive index n≈1.804 at λ=248 nm. All other lenses are made of fused silica with n≈1.51 at λ=248 nm.

The general sequence of objective parts and folding mirrors is similar to that of the above embodiments. Also, a double-pass field lens group FLG2 is provided in the second objective part, and a single-pass, aspheric positive field lens group FLG3 formed by a single biconvex lens is provided between first and second folding mirror FM1, FM2. An alternative folding concept is used in the region around first folding mirror FM1. First folding mirror FM1 is arranged on the same side of the optical axis as the object field, i.e. between the first section OA1 and the third section OA3 of the optical axis. The first intermediate image is formed on the opposite side close to the edge of the first folding mirror FM1 facing away from the second folding mirror FM2. Second intermediate image IMI2 is formed close to the first folding mirror FM1. Like in the embodiments above, the double pass positive field lens FLG2 is effective in both directions towards an from concave mirror, the aspheric convex surface of that field lens being arranged optically very close to both intermediate images IMI1, IMI2 to provide efficient correction of aberrations.

In embodiments of the invention, relatively small lens diameters in the third objective part, particularly in the lenses between the second folding mirror FM2 and the image surface, are made possible by designing the system such that the transverse section of the optical axis (OA2) is arranged relatively closer to the image surface when compared to conventional systems. These features may be characterized by the length ratio A=L2/L1, which is significantly larger than in conventional systems for all embodiments. Avoiding a waist in the third objective part may contribute to keeping the axial length of the third objective part and the overall material consumption small. Further contributions to shortening the axial length may be obtained if negative lenses are avoided between the third pupil surface and the image surface and, in some embodiments, in an axially extended region between a negative lens immediately following the second folding mirror and the image surface.

Table A below summarizes some of the characterizing features of different embodiments.

TABLE A

| FIG. | 2 k541 | 4 k552 | 5 k551 | 6 k553 | 7 k732 |
|---|---|---|---|---|---|
| A | 1.38 | 1.30 | 1.24 | 1.43 | 1.30 |

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

The content of all the claims is made part of this description by reference.

The following tables summarize specifications of embodiments described above. In the tables, column 1 specifies the number of a refractive surface or a reflective surface or a surface distinguished in some other way, column 2 specifies the radius r (radius of curvature) of the surface (in mm), column 3 specifies the distance d—also denoted as thickness—between the surface and the subsequent surface (in mm), and column 4 specifies the material of the optical components. Column 5 indicates the refractive index of the material, and column 6 specifies the optically free radius or the optically free semidiameter (or the lens height) of a lens surface or other surfaces (in mm). Radius r=0 corresponds to a planar surface.

The table or tables are designated by the same numbers as the respective figures. A table with additional designation “A” specifies the corresponding aspheric or other relevant data. The aspheric surfaces are calculated according to the following specification:

p(h)=[((1/r)h²)/(1+SQRT(1−(1+K)(1/r)²h²))]+C1*h⁴+C2*h⁶+

In this case, the reciprocal (1/r) of the radius specifies the surface curvature and h specifies the distance between a surface point and the optical axis (i.e. the ray height). Consequently, p(h) specifies the so-called sagitta, that is to say the distance between the surface point and the surface vertex in the z direction (direction of the optical axis). Constant K is the conic constant, and parameters, C1, C2 are aspheric constants.

TABLE 2

| Des | k541 |
|---|---|
| NA | 1.55 |
| OBH | 61 |

| SURF | RADIUS | THICKNESS | MATERIAL | INDEX | SEMIDIAM. |
|---|---|---|---|---|---|
| 0 | 0.000000 | 70.950202 | | | 61.0 |
| 1 | −709.030305 | 31.353947 | SIO2 | 1.560970 | 88.5 |
| 2 | −203.772146 | 135.309716 | | | 93.7 |
| 3 | −1433.360898 | 52.175996 | SIO2 | 1.560970 | 134.7 |
| 4 | −227.916025 | 0.999799 | | | 137.3 |
| 5 | 174.795533 | 166.903177 | SIO2 | 1.560970 | 128.8 |
| 6 | 1419.139293 | 36.369698 | | | 83.9 |
| 7 | −225.873211 | 9.999987 | SIO2 | 1.560970 | 72.7 |
| 8 | 330.549692 | 13.991458 | | | 78.8 |
| 9 | 322.297530 | 83.884886 | SIO2 | 1.560970 | 87.3 |
| 10 | −172.517348 | 38.757170 | | | 96.0 |
| 11 | −194.541506 | 9.999925 | SIO2 | 1.560970 | 99.0 |
| 12 | 527.218376 | 39.800287 | | | 111.6 |
| 13 | −279.610527 | 40.270238 | SIO2 | 1.560970 | 113.9 |
| 14 | −165.721774 | 0.999880 | | | 120.8 |
| 15 | 722.578035 | 131.580966 | SIO2 | 1.560970 | 142.3 |
| 16 | −226.620147 | 0.999852 | | | 153.4 |
| 17 | 1760.488946 | 18.904496 | SIO2 | 1.560970 | 136.4 |
| 18 | −2500.614852 | 207.114011 | | | 134.4 |
| 19 | 178.007334 | 46.798610 | SIO2 | 1.560970 | 99.1 |
| 20 | 1089.551955 | 180.671270 | | | 97.0 |
| 21 | −137.266296 | 15.000000 | SIO2 | 1.560970 | 81.3 |
| 22 | 20819.593876 | 55.049511 | | | 89.3 |
| 23 | −148.064246 | 15.000000 | SIO2 | 1.560970 | 95.4 |
| 24 | −422.447165 | 30.666134 | | | 111.4 |
| 25 | −175.810043 | −30.666134 | REFL | | 114.9 |
| 26 | −422.447165 | −15.000000 | SIO2 | 1.560970 | 112.2 |
| 27 | −148.064246 | −55.049511 | | | 97.0 |
| 28 | 20819.593876 | −15.000000 | SIO2 | 1.560970 | 92.1 |
| 29 | −137.266296 | −180.671270 | | | 85.0 |
| 30 | 1089.551955 | −46.798610 | SIO2 | 1.560970 | 113.7 |
| 31 | 178.007334 | −75.003570 | | | 115.5 |
| 32 | 0.000000 | 290.347784 | REFL | | 93.7 |
| 33 | 363.958398 | 66.035959 | SIO2 | 1.560970 | 182.8 |
| 34 | −2176.032353 | 343.622371 | | | 183.1 |
| 35 | 0.000000 | −170.087025 | REFL | | 182.3 |
| 36 | −4467.865903 | −19.999748 | SIO2 | 1.560970 | 177.2 |
| 37 | −318.535983 | −18.817372 | | | 180.0 |
| 38 | −320.927783 | −64.109353 | SIO2 | 1.560970 | 190.7 |
| 39 | −7203.031442 | −1.872587 | | | 192.4 |
| 40 | −594.684489 | −63.211917 | SIO2 | 1.560970 | 199.9 |
| 41 | 932.487103 | −96.076213 | | | 200.0 |
| 42 | −311.301521 | −101.966484 | SIO2 | 1.560970 | 200.0 |
| 43 | 910.147260 | −0.999922 | | | 195.8 |
| 44 | −306.698799 | −58.228855 | SIO2 | 1.560970 | 160.7 |
| 45 | −5166.289221 | −0.283099 | | | 154.5 |
| 46 | 0.000000 | −0.716691 | | | 150.7 |
| 47 | −192.139416 | −28.724002 | SIO2 | 1.560970 | 121.3 |
| 48 | −474.365356 | −1.000000 | | | 112.9 |
| 49 | −215.291289 | −29.253902 | SIO2 | 1.560970 | 100.9 |
| 50 | −150.234856 | −1.000000 | | | 81.2 |
| 51 | −96.630680 | −75.350369 | LUAG | 2.145019 | 70.4 |
| 52 | 0.000000 | −3.000000 | HIFLUID | 1.650000 | 23.4 |
| 53 | 0.000000 | 0.000000 | | | 15.3 |

TABLE 2A
Aspheric Constants

| | SRF | | | | |
|---|---|---|---|---|---|
| | 2 | 10 | 15 | 20 | 24 |
| K | 0 | 0 | 0 | 0 | 0 |
| C1 | 3.016437E−08 | 5.254212E−08 | −1.190138E−08 | 2.599792E−09 | −1.747141E−08 |
| C2 | 8.234320E−13 | 1.735902E−12 | 2.472460E−15 | −1.605415E−13 | 4.299034E−13 |
| C3 | 1.849936E−17 | 1.388555E−16 | 4.415579E−18 | 8.766148E−18 | −1.826851E−17 |
| C4 | 6.785416E−22 | −5.973658E−21 | −1.252067E−22 | −2.041588E−22 | 5.575427E−22 |
| C5 | 4.953675E−26 | −1.278117E−26 | 1.786359E−27 | 3.792497E−27 | 4.785422E−27 |
| C6 | 6.317160E−31 | 1.534912E−29 | −8.716692E−33 | −4.484112E−32 | −9.667273E−31 |
| | SRF | | | | |
| | 26 | 30 | 33 | 36 | 38 |
| K | 0 | 0 | 0 | 0 | 0 |
| C1 | −1.747141E−08 | 2.599792E−09 | −5.030145E−09 | 7.969492E−09 | 3.842100E−09 |
| C2 | 4.299034E−13 | −1.605415E−13 | 9.428480E−15 | −1.259690E−13 | 1.572313E−13 |
| C3 | −1.826851E−17 | 8.766148E−18 | −2.582893E−19 | 3.894278E−18 | −2.943307E−18 |
| C4 | 5.575427E−22 | −2.041588E−22 | 3.093907E−24 | −4.971331E−23 | 4.866235E−23 |
| C5 | 4.785422E−27 | 3.792497E−27 | −4.015425E−29 | 4.300471E−28 | −5.336702E−28 |
| C6 | −9.667273E−31 | −4.484112E−32 | 2.021351E−34 | −3.050226E−34 | 5.300579E−33 |
| | SRF | | | | |
| | 41 | 43 | 45 | 47 | 50 |
| K | 0 | 0 | 0 | 0 | 0 |
| C1 | −4.814477E−09 | −1.078382E−08 | 2.079353E−08 | 3.258622E−08 | 3.571394E−08 |
| C2 | −3.031482E−16 | 3.333547E−13 | −8.637669E−13 | 1.202033E−12 | 2.090979E−12 |
| C3 | 2.712195E−20 | −8.324760E−18 | 2.470669E−17 | 1.124432E−16 | 1.927750E−15 |
| C4 | −2.123980E−23 | 1.421470E−22 | −6.727959E−22 | −9.257948E−22 | −3.599450E−19 |
| C5 | 2.822511E−28 | −1.352382E−27 | 1.240338E−26 | −3.158029E−25 | 2.470851E−23 |
| C6 | −1.392126E−33 | 5.535899E−33 | −1.166406E−31 | 1.055496E−29 | −6.019295E−28 |

TABLE 4

| Des | k552 |
|---|---|
| NA | 1.55 |
| OBH | 61 |

| SURF | RADIUS | THICKNESS | MATERIAL | INDEX | SEMIDIAM. |
|---|---|---|---|---|---|
| 0 | 0.000000 | 80.319687 | | | 61.0 |
| 1 | 324.429615 | 26.325489 | SIO2 | 1.560970 | 101.6 |
| 2 | −17520.754016 | 95.672398 | | | 103.0 |
| 3 | 13230.338325 | 52.244589 | SIO2 | 1.560970 | 126.2 |
| 4 | −212.156920 | 47.347608 | | | 128.7 |
| 5 | 194.068321 | 50.317430 | SIO2 | 1.560970 | 115.6 |
| 6 | 4018.549677 | 47.076194 | | | 112.9 |
| 7 | −206.063657 | 20.000054 | SIO2 | 1.560970 | 93.5 |
| 8 | −868.194659 | 22.114633 | | | 88.6 |
| 9 | 0.000000 | 10.000000 | SIO2 | 1.560970 | 81.5 |
| 10 | 0.000000 | 34.922603 | | | 83.1 |
| 11 | −5009.568529 | 29.999957 | SIO2 | 1.560970 | 92.1 |
| 12 | 303.522539 | 6.865589 | | | 100.3 |
| 13 | 377.849440 | 53.270270 | SIO2 | 1.560970 | 102.6 |
| 14 | −172.786454 | 76.839169 | | | 104.6 |
| 15 | −323.731128 | 15.000000 | SIO2 | 1.560970 | 109.5 |
| 16 | 556.359098 | 47.253212 | | | 117.1 |
| 17 | −652.792792 | 43.256957 | SIO2 | 1.560970 | 126.4 |
| 18 | −217.267859 | 38.321071 | | | 130.4 |
| 19 | 579.144315 | 65.565898 | SIO2 | 1.560970 | 142.8 |
| 20 | −270.202245 | 198.186091 | | | 143.0 |
| 21 | 161.753419 | 40.416137 | SIO2 | 1.560970 | 98.5 |
| 22 | 463.157880 | 176.121023 | | | 96.0 |
| 23 | −140.022479 | 15.000000 | SIO2 | 1.560970 | 82.5 |
| 24 | −484.727560 | 50.786427 | | | 89.0 |
| 25 | −114.842091 | 15.000000 | SIO2 | 1.560970 | 91.6 |
| 26 | −475.926800 | 37.524456 | | | 114.9 |
| 27 | −169.099859 | −37.524456 | REFL | | 118.7 |
| 28 | −475.926800 | −15.000000 | SIO2 | 1.560970 | 115.5 |
| 29 | −114.842091 | −50.786427 | | | 92.6 |
| 30 | −484.727560 | −15.000000 | SIO2 | 1.560970 | 90.7 |
| 31 | −140.022479 | −176.121023 | | | 84.9 |
| 32 | 463.157880 | −40.416137 | SIO2 | 1.560970 | 107.8 |
| 33 | 161.753419 | −71.058956 | | | 109.9 |
| 34 | 0.000000 | 268.465298 | REFL | | 90.3 |
| 35 | 555.696724 | 68.188266 | SIO2 | 1.560970 | 177.3 |
| 36 | −578.026593 | 363.343849 | | | 179.2 |
| 37 | 0.000000 | −183.968925 | REFL | | 189.1 |
| 38 | −1866.937793 | −28.283239 | SIO2 | 1.560970 | 190.7 |
| 39 | −287.485222 | −25.837913 | | | 187.1 |
| 40 | −350.074108 | −77.914429 | SIO2 | 1.560970 | 191.0 |
| 41 | 1229.131082 | −0.999226 | | | 192.9 |
| 42 | −1051.125169 | −52.084221 | SIO2 | 1.560970 | 197.4 |
| 43 | 891.094263 | −97.868162 | | | 197.6 |
| 44 | −480.428917 | −56.818284 | SIO2 | 1.560970 | 200.2 |
| 45 | −5829.810774 | −1.000000 | | | 197.8 |
| 46 | −226.325644 | −99.297026 | SIO2 | 1.560970 | 173.9 |
| 47 | −1253.494884 | −1.000000 | | | 162.1 |
| 48 | −244.729008 | −28.799444 | SIO2 | 1.560970 | 135.1 |
| 49 | −619.335586 | −1.000000 | | | 128.4 |
| 50 | −129.173994 | −29.124439 | SIO2 | 1.560970 | 99.1 |
| 51 | −166.690645 | −1.000000 | | | 92.3 |
| 52 | −91.560326 | −72.205999 | SPINELL | 1.910000 | 73.1 |
| 53 | 0.000000 | −3.000000 | HIFLUID | 1.650000 | 23.5 |
| 54 | 0.000000 | 0.000000 | | | 15.3 |

TABLE 4A
Aspheric Constants

| | SRF | | | | |
|---|---|---|---|---|---|
| | 2 | 3 | 6 | 14 | 19 |
| K | 0 | 0 | 0 | 0 | 0 |
| C1 | 1.060438E−08 | −2.311274E−08 | −2.771814E−08 | 4.000685E−08 | −6.422111E−09 |
| C2 | 1.389738E−12 | 2.710436E−13 | −2.880353E−13 | 6.524731E−13 | −6.916943E−14 |
| C3 | −5.683650E−17 | 1.768431E−17 | −1.840112E−18 | 3.551925E−17 | 2.437575E−18 |
| C4 | 3.579943E−21 | −1.368341E−21 | 5.087777E−22 | 1.659153E−22 | −3.993249E−23 |
| C5 | −6.396701E−26 | 5.462166E−26 | 2.665561E−27 | −1.018634E−26 | 6.531629E−28 |
| C6 | 1.125551E−30 | −8.558517E−31 | −2.613749E−31 | 2.520616E−30 | −8.380176E−33 |
| | SRF | | | | |
| | 22 | 26 | 28 | 32 | 35 |
| K | 0 | 0 | 0 | 0 | 0 |
| C1 | 7.034698E−09 | −1.756064E−08 | −1.756064E−08 | 7.034698E−09 | −4.492279E−09 |
| C2 | −4.686631E−13 | 8.110489E−13 | 8.110489E−13 | −4.686631E−13 | 2.852173E−14 |
| C3 | 1.626516E−17 | −3.577628E−17 | −3.577628E−17 | 1.626516E−17 | −7.408198E−19 |
| C4 | −5.948093E−22 | 1.296413E−21 | 1.296413E−21 | −5.948093E−22 | 1.593213E−23 |
| C5 | 2.530997E−26 | −2.184244E−26 | −2.184244E−26 | 2.530997E−26 | −2.008626E−28 |
| C6 | −5.709240E−31 | −3.075320E−31 | −3.075320E−31 | −5.709240E−31 | 1.775466E−33 |
| | SRF | | | | |
| | 38 | 40 | 43 | 45 | 47 |
| K | 0 | 0 | 0 | 0 | 0 |
| C1 | 7.492350E−09 | 1.907307E−09 | 7.053076E−10 | −1.274550E−08 | 2.408308E−08 |
| C2 | −3.650528E−13 | 2.990001E−13 | −1.476539E−14 | 4.263365E−13 | −7.974317E−13 |
| C3 | 9.662995E−18 | −9.190521E−18 | −1.930754E−18 | −2.058208E−18 | 1.011043E−17 |
| C4 | −2.133382E−22 | 1.723611E−22 | 9.819050E−24 | 1.225724E−23 | 1.072854E−22 |
| C5 | 2.603601E−27 | −2.527394E−27 | −2.259799E−28 | −9.492788E−28 | −3.828518E−27 |
| C6 | −1.264950E−32 | 2.030346E−32 | −2.902338E−33 | 1.024631E−32 | 1.840016E−32 |

SRF

| | 48 | 51 |
|---|---|---|
| K | 0 | 0 |
| C1 | −6.470411E−09 | 2.173093E−08 |
| C2 | 1.873386E−12 | 3.389860E−12 |
| C3 | 1.995626E−17 | 5.322256E−16 |
| C4 | −3.349483E−22 | −1.169561E−19 |
| C5 | −3.598032E−26 | 8.197014E−24 |
| C6 | 7.971223E−31 | −2.100043E−28 |

TABLE 5

| Des | k551 |
|---|---|
| NA | 1.55 |
| OBH | 61 |

| SURF | RADIUS | THICKNESS | MATERIAL | INDEX | SEMIDIAM. |
|---|---|---|---|---|---|
| 0 | 0.000000 | 32.999979 | | | 61.0 |
| 1 | 458.276355 | 74.271275 | SIO2 | 1.560970 | 77.7 |
| 2 | −991.015796 | 102.519666 | | | 89.6 |
| 3 | −1423.344985 | 50.309028 | SIO2 | 1.560970 | 116.2 |
| 4 | −174.506339 | 80.300578 | | | 120.5 |
| 5 | 205.719028 | 57.021382 | SIO2 | 1.560970 | 116.2 |
| 6 | −1038.638394 | 29.224527 | | | 114.0 |
| 7 | −249.148065 | 9.999656 | SIO2 | 1.560970 | 99.1 |
| 8 | −1973.977201 | 21.747667 | | | 94.3 |
| 9 | 0.000000 | 10.000000 | SIO2 | 1.560970 | 86.9 |
| 10 | 0.000000 | 42.541545 | | | 87.9 |
| 11 | 567.321152 | 30.000033 | SIO2 | 1.560970 | 95.8 |
| 12 | 237.920095 | 5.056308 | | | 97.3 |
| 13 | 220.618708 | 57.454026 | SIO2 | 1.560970 | 100.3 |
| 14 | −197.649469 | 52.388319 | | | 100.4 |
| 15 | −127.371241 | 15.000000 | SIO2 | 1.560970 | 91.2 |
| 16 | 518.102159 | 38.849354 | | | 105.1 |
| 17 | −262.819709 | 36.470454 | SIO2 | 1.560970 | 107.7 |
| 18 | −159.879458 | 15.053911 | | | 113.7 |
| 19 | 498.713964 | 69.576324 | SIO2 | 1.560970 | 134.0 |
| 20 | −224.586195 | 209.125144 | | | 135.0 |
| 21 | 193.672246 | 50.000059 | SIO2 | 1.560970 | 109.7 |
| 22 | 4883.610055 | 210.681578 | | | 107.9 |
| 23 | −136.579153 | 15.000000 | SIO2 | 1.560970 | 87.0 |
| 24 | 2345.069453 | 52.948128 | | | 97.2 |
| 25 | −146.740087 | 15.000000 | SIO2 | 1.560970 | 101.1 |
| 26 | −445.327675 | 35.471205 | | | 120.9 |
| 27 | −178.570928 | −35.471205 | REFL | | 124.7 |
| 28 | −445.327675 | −15.000000 | SIO2 | 1.560970 | 121.3 |
| 29 | −146.740087 | −52.948128 | | | 102.1 |
| 30 | 2345.069453 | −15.000000 | SIO2 | 1.560970 | 98.8 |
| 31 | −136.579153 | −210.681578 | | | 89.1 |
| 32 | 4883.610055 | −50.000059 | SFO2 | 1.560970 | 119.6 |
| 33 | 193.672246 | −71.059045 | | | 121.1 |
| 34 | 0.000000 | 341.187185 | REFL | | 97.6 |
| 35 | 387.496770 | 50.000028 | SIO2 | 1.560970 | 187.8 |
| 36 | 325.978631 | 26.133787 | | | 188.0 |
| 37 | 414.344938 | 89.698552 | SIO2 | 1.560970 | 197.2 |
| 38 | −808.033025 | 192.969112 | | | 198.4 |
| 39 | 0.000000 | −207.564107 | REFL | | 197.6 |
| 40 | −93528.111861 | −19.999816 | SIO2 | 1.560970 | 189.4 |
| 41 | −277.428441 | −35.916821 | | | 184.0 |
| 42 | −354.187752 | −76.678892 | SIO2 | 1.560970 | 193.5 |
| 43 | 1359.610410 | −1.276918 | | | 195.3 |
| 44 | −1619.446821 | −52.808628 | SIO2 | 1.560970 | 198.4 |
| 45 | 665.774122 | −93.431343 | | | 198.8 |
| 46 | −395.659683 | −62.449306 | SIO2 | 1.560970 | 200.5 |
| 47 | 438485.897219 | −1.000000 | | | 197.7 |
| 48 | −223.209196 | −93.791295 | SIO2 | 1.560970 | 173.3 |
| 49 | −1110.856278 | −1.000000 | | | 163.8 |
| 50 | −329.430665 | −28.506056 | SIO2 | 1.560970 | 144.8 |
| 51 | −1431.882481 | −1.000000 | | | 139.0 |
| 52 | −144.030074 | −26.196013 | SIO2 | 1.560970 | 103.4 |
| 53 | −181.017481 | −1.000000 | | | 96.6 |
| 54 | −94.972931 | −75.542695 | SPINELL | 1.910000 | 75.9 |
| 55 | 0.000000 | −3.000000 | HIFLUID | 1.650000 | 23.5 |
| 56 | 0.000000 | 0.000000 | | | 15.3 |

TABLE 5A
Aspheric Constants

| | SRF | | | | |
|---|---|---|---|---|---|
| | 2 | 3 | 6 | 14 | 19 |
| K | 0 | 0 | 0 | 0 | 0 |
| C1 | 5.641392E−09 | −4.869803E−08 | −4.645914E−08 | 3.682970E−08 | −1.151780E−08 |
| C2 | 1.851518E−12 | 3.276350E−13 | −1.732841E−13 | 4.433642E−13 | −5.769000E−15 |
| C3 | −1.579266E−17 | 2.637534E−17 | 1.706107E−16 | 1.662495E−17 | 2.936382E−18 |
| C4 | 1.319873E−22 | −1.313365E−21 | −1.133520E−20 | −3.045119E−21 | −7.661490E−23 |
| C5 | 1.511144E−25 | 3.607432E−26 | 3.686676E−25 | 6.571349E−26 | 6.799445E−28 |
| C6 | −1.463642E−30 | −7.068119E−31 | −5.055295E−30 | −7.832424E−30 | 3.486066E−33 |
| | SRF | | | | |
| | 22 | 26 | 28 | 32 | 35 |
| K | 0 | 0 | 0 | 0 | 0 |
| C1 | 9.314623E−09 | −2.172204E−08 | −2.172204E−08 | 9.314623E−09 | −3.712216E−09 |
| C2 | −1.874335E−13 | 5.565412E−13 | 5.565412E−13 | −1.874335E−13 | 1.875355E−14 |
| C3 | 4.997149E−18 | −2.374354E−17 | −2.374354E−17 | 4.997149E−18 | −1.634917E−19 |
| C4 | −6.108936E−23 | 7.222642E−22 | 7.222642E−22 | −6.108936E−23 | 3.876596E−24 |
| C5 | 1.310716E−27 | −2.032497E−26 | −2.032497E−26 | 1.310716E−27 | −4.847661E−29 |
| C6 | −4.187944E−32 | 2.999346E−31 | 2.999346E−31 | −4.187944E−32 | 1.452126E−33 |
| | SRF | | | | |
| | 40 | 42 | 45 | 47 | 49 |
| K | 0 | 0 | 0 | 0 | 0 |
| C1 | 6.469574E−09 | 2.657094E−09 | 4.027653E−10 | −1.862934E−08 | 1.950502E−08 |
| C2 | −4.356302E−13 | 2.819228E−13 | −4.618888E−14 | 5.258847E−13 | −5.975915E−13 |
| C3 | 1.053679E−17 | −8.354914E−18 | −2.967874E−19 | −6.810219E−18 | 9.589708E−18 |
| C4 | −2.130922E−22 | 1.539903E−22 | −2.358641E−23 | 1.257479E−22 | −1.507359E−23 |
| C5 | 2.311420E−27 | −2.491188E−27 | 1.299619E−28 | −1.900015E−27 | −1.529431E−27 |
| C6 | −9.474614E−33 | 2.022486E−32 | −5.594083E−33 | 1.128804E−32 | 8.808853E−33 |

SRF

| | 50 | 53 |
|---|---|---|
| K | 0 | 0 |
| C1 | −1.329172E−08 | 1.709629E−08 |
| C2 | 2.080183E−12 | 2.687421E−12 |
| C3 | −2.002180E−17 | 3.343861E−16 |
| C4 | 1.543886E−22 | −7.555544E−20 |
| C5 | −1.995523E−26 | 4.966198E−24 |
| C6 | 3.402103E−31 | −1.220927E−28 |

TABLE 6

| Des | k553 |
|---|---|
| NA | 1.55 |
| OBH | 61 |

| SURF | RADIUS | THICKNESS | MATERIAL | INDEX | SEMIDIAM. |
|---|---|---|---|---|---|
| 0 | 0.000000 | 45.112617 | | | 61.0 |
| 1 | 369.235752 | 37.823481 | SIO2 | 1.560970 | 84.0 |
| 2 | −4605.173358 | 66.092598 | | | 88.6 |
| 3 | −318.906392 | 54.993418 | SIO2 | 1.560970 | 102.4 |
| 4 | −151.288531 | 166.071276 | | | 112.4 |
| 5 | 235.793859 | 47.680486 | SIO2 | 1.560970 | 121.5 |
| 6 | −3279.636121 | 48.706534 | | | 119.1 |
| 7 | 0.000000 | 10.000000 | SIO2 | 1.560970 | 104.6 |
| 8 | 0.000000 | 108.977343 | | | 105.1 |
| 9 | 613.751175 | 56.901528 | SIO2 | 1.560970 | 115.3 |
| 10 | −174.876212 | 35.249161 | | | 115.1 |
| 11 | −178.250613 | 15.000000 | SIO2 | 1.560970 | 103.1 |
| 12 | 422.250338 | 42.273493 | | | 107.4 |
| 13 | −257.009890 | 58.306779 | SIO2 | 1.560970 | 108.6 |
| 14 | −187.855329 | 55.751724 | | | 121.5 |
| 15 | 368.989370 | 68.406103 | SIO2 | 1.560970 | 133.4 |
| 16 | −314.750915 | 194.433997 | | | 132.5 |
| 17 | 160.881239 | 38.566376 | SIO2 | 1.560970 | 101.3 |
| 18 | 422.159443 | 185.989402 | | | 99.1 |
| 19 | −131.670074 | 15.000000 | SIO2 | 1.560970 | 88.5 |
| 20 | 6567.615380 | 47.479233 | | | 101.5 |
| 21 | −148.161544 | 15.000000 | SIO2 | 1.560970 | 103.5 |
| 22 | −403.269210 | 36.254262 | | | 123.9 |
| 23 | −178.364238 | −36.254262 | REFL | | 128.6 |
| 24 | −403.269210 | −15.000000 | SIO2 | 1.560970 | 124.7 |
| 25 | −148.161544 | −47.479233 | | | 104.6 |
| 26 | 6567.615380 | −15.000000 | SIO2 | 1.560970 | 103.2 |
| 27 | −131.670074 | −185.989402 | | | 90.6 |
| 28 | 422.159443 | −38.566376 | SIO2 | 1.560970 | 107.8 |
| 29 | 160.881239 | −81.849311 | | | 109.8 |
| 30 | 0.000000 | 222.220723 | REFL | | 84.5 |
| 31 | 2293.558427 | 44.056041 | SIO2 | 1.560970 | 155.0 |
| 32 | −448.156605 | 185.458363 | | | 157.7 |
| 33 | 332.440638 | 43.497364 | SIO2 | 1.560970 | 199.5 |
| 34 | 518.606311 | 204.762356 | | | 196.8 |
| 35 | 0.000000 | −192.210737 | REFL | | 194.0 |
| 36 | −2725.783413 | −72.224353 | SIO2 | 1.560970 | 181.5 |
| 37 | −943.614325 | −0.999817 | | | 184.2 |
| 38 | −330.340761 | −79.416221 | SIO2 | 1.560970 | 200.0 |
| 39 | 2125.818125 | −80.512683 | | | 198.6 |
| 40 | −480.278036 | −52.831959 | SIO2 | 1.560970 | 197.7 |
| 41 | 1468.144942 | −1.000000 | | | 195.2 |
| 42 | −338.205468 | −94.989450 | SIO2 | 1.560970 | 182.7 |
| 43 | 1787.701866 | −1.000000 | | | 172.3 |
| 44 | −310.816721 | −22.972740 | SIO2 | 1.560970 | 143.3 |
| 45 | −820.550566 | −1.000000 | | | 139.8 |
| 46 | −203.974076 | −32.120188 | SIO2 | 1.560970 | 122.1 |
| 47 | −255.534959 | −1.000000 | | | 117.6 |
| 48 | −94.077573 | −77.862358 | SPINELL | 1.910000 | 80.6 |
| 49 | 0.000000 | −2.000000 | HIFLUID | 1.650000 | 35.9 |
| 50 | 0.000000 | −5.000000 | SPINELL | 1.910000 | 30.4 |
| 51 | 0.000000 | −3.000000 | HIFLUID | 1.650000 | 23.5 |
| 52 | 0.000000 | 0.000000 | | | 15.3 |

TABLE 6A
Aspheric Constants

| | SRF | | | | |
|---|---|---|---|---|---|
| | 2 | 3 | 6 | 10 | 15 |
| K | 0 | 0 | 0 | 0 | 0 |
| C1 | 1.390906E−08 | −5.164317E−08 | −5.048762E−09 | 5.956413E−08 | −4.700315E−09 |
| C2 | 1.804471E−12 | 5.617096E−13 | 1.018268E−12 | −2.439975E−13 | −1.823851E−13 |
| C3 | 2.822637E−17 | 3.572423E−19 | −2.420371E−17 | 2.625679E−17 | 4.428208E−18 |
| C4 | −2.596872E−21 | 2.309862E−21 | −1.599775E−21 | −4.064941E−22 | −1.115406E−22 |
| C5 | 7.191239E−25 | −1.561857E−25 | 1.134383E−25 | 1.668054E−26 | 2.591750E−27 |
| C6 | −9.139791E−31 | 1.773239E−29 | −1.120546E−30 | 8.131926E−32 | −3.244212E−32 |
| | SRF | | | | |
| | 18 | 22 | 24 | 28 | 31 |
| K | 0 | 0 | 0 | 0 | 0 |
| C1 | 1.210092E−08 | −2.193791E−08 | −2.193791E−08 | 1.210092E−08 | −2.351971E−09 |
| C2 | −2.531452E−13 | 3.858022E−13 | 3.858022E−13 | −2.531452E−13 | −1.575891E−15 |
| C3 | 1.295337E−18 | −2.226718E−17 | −2.226718E−17 | 1.295337E−18 | 7.990448E−20 |
| C4 | −3.923399E−22 | 8.298631E−22 | 8.298631E−22 | −3.923399E−22 | −3.293916E−23 |
| C5 | 2.603580E−26 | −3.004122E−26 | −3.004122E−26 | 2.603580E−26 | 1.253933E−27 |
| C6 | −6.494324E−31 | 6.476350E−31 | 6.476350E−31 | −6.494324E−31 | −1.261865E−32 |
| | SRF | | | | |
| | 36 | 37 | 39 | 41 | 43 |
| K | 0 | 0 | 0 | 0 | 0 |
| C1 | 1.591721E−08 | 8.198269E−09 | −8.641888E−09 | −2.587231E−08 | 1.714965E−08 |
| C2 | −8.246061E−14 | −2.340748E−13 | 1.671752E−13 | 4.118297E−13 | −5.458146E−13 |
| C3 | −1.733562E−18 | −1.895685E−18 | −4.414343E−18 | −5.075777E−18 | 1.143433E−17 |
| C4 | −5.108327E−23 | −5.108773E−23 | 3.794751E−23 | 1.672760E−22 | −2.880479E−22 |
| C5 | 1.414078E−27 | 1.159451E−27 | −6.783975E−28 | −2.002696E−27 | 4.625859E−27 |
| C6 | 4.277105E−33 | −1.136437E−32 | 2.691561E−33 | 5.269556E−33 | −3.651087E−32 |

SRF

| | 44 | 47 |
|---|---|---|
| K | 0 | 0 |
| C1 | −1.749512E−08 | 7.133622E−08 |
| C2 | 2.355481E−12 | 1.378615E−12 |
| C3 | −5.435830E−17 | −1.441726E−16 |
| C4 | 3.060716E−21 | 9.217066E−22 |
| C5 | −1.051454E−25 | 1.818637E−25 |
| C6 | 1.008359E−30 | −5.981573E−30 |

TABLE 7

| | |
|---|---|
| NA | 1.48 |
| OBH | 61 |
| WL | 248 |

| SURF | RADIUS | THICKNESS | MATERIAL | INDEX1 | SEMIDIAM. |
|---|---|---|---|---|---|
| 0 | 0.000000 | 77.889658 | | | 61.0 |
| 1 | 250.906379 | 25.858255 | SIO2 | 1.508658 | 100.4 |
| 2 | 881.904022 | 98.836963 | | | 101.4 |
| 3 | 2042.204502 | 52.891711 | SIO2 | 1.508658 | 124.5 |
| 4 | −220.862711 | 31.809670 | | | 126.9 |
| 5 | 187.246667 | 53.162245 | SIO2 | 1.508658 | 118.6 |
| 6 | 21308.743975 | 70.671001 | | | 116.0 |
| 7 | −194.112766 | 10.043229 | SIO2 | 1.508658 | 87.2 |
| 8 | −745.931728 | 21.002764 | | | 84.2 |
| 9 | 0.000000 | 10.000000 | SIO2 | 1.508658 | 78.2 |
| 10 | 0.000000 | 20.787398 | | | 80.1 |
| 11 | −14834.299876 | 29.999927 | SIO2 | 1.508658 | 86.3 |
| 12 | 352.407418 | 16.125799 | | | 94.9 |
| 13 | 348.390759 | 56.335240 | SIO2 | 1.508658 | 104.8 |
| 14 | −169.633284 | 82.596842 | | | 106.6 |
| 15 | −432.191040 | 15.000000 | SIO2 | 1.508658 | 109.7 |
| 16 | 418.110222 | 52.952495 | | | 114.6 |
| 17 | −679.885525 | 43.660366 | SIO2 | 1.508658 | 123.3 |
| 18 | −208.956853 | 51.255259 | | | 126.8 |
| 19 | 411.730362 | 62.858269 | SIO2 | 1.508658 | 134.5 |
| 20 | −294.169282 | 175.745415 | | | 134.0 |
| 21 | 152.468735 | 39.816377 | SIO2 | 1.508658 | 92.8 |
| 22 | 403.386105 | 175.210417 | | | 90.3 |
| 23 | −129.436044 | 15.000000 | SIO2 | 1.508658 | 79.0 |
| 24 | −655.573838 | 55.570245 | | | 86.2 |
| 25 | −110.921985 | 15.000000 | SIO2 | 1.508658 | 89.7 |
| 26 | −479.151499 | 36.246889 | | | 114.2 |
| 27 | −169.652097 | −36.246889 | REFL | | 117.9 |
| 28 | −479.151499 | −15.000000 | SIO2 | 1.508658 | 114.5 |
| 29 | −110.921985 | −55.570245 | | | 90.9 |
| 30 | −655.573838 | −15.000000 | SIO2 | 1.508658 | 88.3 |
| 31 | −129.436044 | −175.210417 | | | 82.0 |
| 32 | 403.386105 | −39.816377 | SIO2 | 1.508658 | 104.5 |
| 33 | 152.468735 | −71.058953 | | | 106.7 |
| 34 | 0.000000 | 241.033061 | REFL | | 86.1 |
| 35 | 492.816600 | 68.154843 | SIO2 | 1.508658 | 165.2 |
| 36 | −492.080540 | 390.823592 | | | 167.2 |
| 37 | 0.000000 | −183.968905 | REFL | | 181.1 |
| 38 | −2149.247650 | −21.713677 | SIO2 | 1.508658 | 182.2 |
| 39 | −272.317100 | −33.789235 | | | 179.7 |
| 40 | −345.636553 | −82.863234 | SIO2 | 1.508658 | 189.5 |
| 41 | 926.993103 | −0.999742 | | | 191.5 |
| 42 | −1023.343993 | −52.767966 | SIO2 | 1.508658 | 196.2 |
| 43 | 754.461714 | −83.081436 | | | 196.3 |
| 44 | −475.571083 | −68.613456 | SIO2 | 1.508658 | 200.2 |
| 45 | 21871.726397 | −1.000000 | | | 197.4 |
| 46 | −223.965973 | −96.007813 | SIO2 | 1.508658 | 171.3 |
| 47 | −1365.382467 | −1.000000 | | | 161.5 |
| 48 | −268.560998 | −28.193524 | SIO2 | 1.508658 | 137.1 |
| 49 | −816.962531 | −1.000000 | | | 131.0 |
| 50 | −123.148966 | −32.709717 | SIO2 | 1.508658 | 98.2 |
| 51 | −172.271693 | −1.000000 | | | 91.4 |
| 52 | −84.770638 | −69.929845 | SPINELL | 1.804084 | 70.2 |
| 53 | 0.000000 | −3.000000 | IMMERS | 1.580000 | 23.3 |
| 54 | 0.000000 | 0.000000 | | | 15.3 |

TABLE 7A
Aspheric Constants

| | SRF | | | | |
|---|---|---|---|---|---|
| | 2 | 3 | 6 | 14 | 19 |
| K | 0 | 0 | 0 | 0 | 0 |
| C1 | 1.441285E−08 | −2.062936E−08 | −1.248258E−08 | 4.621809E−08 | −6.844394E−09 |
| C2 | 1.594687E−12 | 2.813228E−13 | 6.494753E−14 | 6.953615E−13 | −1.019034E−13 |
| C3 | −1.098505E−16 | 7.806549E−18 | −1.292946E−17 | 3.172366E−17 | 2.643417E−18 |
| C4 | 7.925123E−21 | −9.652414E−22 | −3.536309E−22 | −3.476815E−22 | −4.060322E−23 |
| C5 | −3.071182E−25 | 4.432152E−26 | 7.224174E−26 | −6.918206E−27 | 7.739194E−28 |
| C6 | 7.071634E−30 | −5.729398E−31 | −1.981098E−30 | 1.023372E−30 | −1.231254E−32 |
| | SRF | | | | |
| | 22 | 26 | 28 | 32 | 35 |
| K | 0 | 0 | 0 | 0 | 0 |
| C1 | 8.657364E−09 | −1.942692E−08 | −1.942692E−08 | 8.657364E−09 | −6.382315E−09 |
| C2 | −6.347512E−13 | 7.841694E−13 | 7.841694E−13 | −6.347512E−13 | 4.416743E−14 |
| C3 | 2.321551E−17 | −3.641552E−17 | −3.641552E−17 | 2.321551E−17 | −1.324291E−18 |
| C4 | −9.923083E−22 | 1.445068E−21 | 1.445068E−21 | −9.923083E−22 | 3.587495E−23 |
| C5 | 3.637179E−26 | −3.698300E−26 | −3.698300E−26 | 3.637179E−26 | −5.980149E−28 |
| C6 | −5.748114E−31 | 3.011537E−31 | 3.011537E−31 | −5.748114E−31 | 5.592917E−33 |
| | SRF | | | | |
| | 38 | 40 | 43 | 45 | 47 |
| K | 0 | 0 | 0 | 0 | 0 |
| C1 | 9.015675E−09 | 1.616261E−09 | −1.532530E−09 | −9.875450E−09 | 2.501427E−08 |
| C2 | −4.382981E−13 | 3.063026E−13 | −1.978432E−14 | 3.976420E−13 | −7.360451E−13 |
| C3 | 1.023939E−17 | −9.320854E−18 | −1.819233E−18 | −2.644273E−18 | 9.799765E−18 |
| C4 | −2.116710E−22 | 1.716732E−22 | 7.178164E−24 | 1.045631E−23 | 2.331379E−23 |
| C5 | 2.391676E−27 | −2.428815E−27 | −3.038139E−28 | −3.473428E−28 | −2.414017E−27 |
| C6 | −9.330057E−33 | 2.060404E−32 | −1.533486E−33 | 3.276501E−33 | 1.791406E−32 |

SRF

| | 48 | 51 |
|---|---|---|
| K | 0 | 0 |
| C1 | −6.543339E−09 | 2.337823E−08 |
| C2 | 1.976836E−12 | 3.171770E−12 |
| C3 | −8.011421E−19 | 2.700009E−16 |
| C4 | 4.830772E−22 | −7.860244E−20 |
| C5 | −6.631888E−26 | 5.759275E−24 |
| C6 | 1.244450E−30 | −1.561052E−28 |

What is claimed is:

1. A catadioptric projection objective comprising:
a plurality of optical elements arranged along an optical axis to image a pattern from an object field in an object surface of the objective to an image field in an image surface region of the objective at an image-side numerical aperture NA with electromagnetic radiation defining an operating wavelength λ, including:
a first objective part configured to image the pattern from the object surface into a first intermediate image, and having a first pupil surface;
a second objective part configured to image the first intermediate image into a second intermediate image, and having a second pupil surface optically conjugate to the first pupil surface, the second objective part including a concave mirror having a reflective mirror surface positioned at or close to the second pupil surface;
a third objective part configured to image the second intermediate image into the image surface, and having a third pupil surface optically conjugate to the first and second pupil surface;
wherein the concave mirror is arranged coaxial with the first objective part to receive radiation from the object surface;
a first deflecting mirror is arranged to deflect radiation reflected from the concave mirror towards a second deflecting mirror;
the second deflecting mirror is arranged to deflect radiation from the first deflecting mirror towards the image surface such that the image surface is parallel to the object surface,
wherein the projection objective has an immersion lens group having a convex object-side entry surface bounding at a gas or vacuum and an image-side exit surface in contact with an immersion liquid in operation, wherein the immersion lens group is at least partly made of a high-index material with refractive index n≧1.6 at the operating wavelength.

2. Projection objective according to claim 1, wherein the immersion lens group is a monolithic plano-convex lens made of the high-index material.

3. Projection objective according to claim 1, wherein the high-index material is chosen from the group consisting of aluminum oxide (Al₂O₃), beryllium oxide (BeO), magnesium aluminum oxide (MgAlO₄, spinell), yttrium aluminium oxide (Y₃Al₅O₁₂), yttrium oxide (Y₂O₃), lanthanum fluoride (LaF₃), lutetium aluminium garnet (LuAG), magnesium oxide (MgO), calcium oxide (CaO), lithium barium fluoride (LiBaF₃).

4. Projection objective according to claim 1, wherein the projection objective has an image-side numerical aperture NA≧1.35.

5. Projection objective according to claim 1, wherein L1 is a geometrical distance between the object surface and an intersection point of the first section of the optical axis and a plane defined by the first deflecting mirror; L2 is a geometrical distance between the intersection point of the first section of the optical axis and the plane defined by the first deflecting mirror, and the image surface such that L=L1+L2; and the condition 1.06<A=L1/L2 holds.

6. Projection objective according to claim 1, further comprising a field lens with positive refractive power arranged geometrically between the first deflecting mirror and the second deflecting mirror.

7. Projection objective according to claim 6, wherein the field lens is a single lens.

8. Projection objective according to claim 7, wherein the field lens has at least one aspheric lens surface.

9. Projection objective according to claim 8, wherein the aspheric lens surface is the lens surface which faces the second intermediate image.

10. Projection objective according to claim 7, wherein no lens is arranged in addition to the field lens geometrically between the first deflecting mirror and the second deflecting mirror

11. Projection objective according to claim 1, further comprising a variable aperture stop having an aperture stop edge that determines the aperture stop diameter, where an axial position of the aperture stop edge with reference to the optical axis of the projection objective varies as a function of the aperture stop diameter.

12. Projection objective according to claim 11, wherein the aperture stop is arranged in the third objective part at or optically close to the third pupil surface and the image surface.

13. Projection objective according to claim 1, further comprising an aperture stop arranged in the first objective part at or close to the first pupil surface.

14. Projection objective according to claim 13, wherein the aperture stop is a variable aperture stop.

15. Projection objective according to claim 1, wherein the third objective part has a lens with a maximum lens diameter arranged close to the third pupil surface, lens diameters increase monotonically between the second intermediate and the lens with maximum diameter and decrease monotonically between the lens with maximum diameter and the image surface.

16. Projection objective according to claim 5, wherein the condition L_{neg}>L2/2 is fulfilled for an axial distance L_{neg} between an exit surface of a last negative lens upstream of the image surface and the image surface.

17. Projection objective according to claim 1, wherein the projection objective has at least one biaspheric lens having an aspheric entry surface and an aspheric exit surface.

18. A projection exposure apparatus comprising:
a light source generating primary radiation;
an illumination system forming the primary radiation to generate illumination radiation incident on a mask bearing a pattern;
a projection objective according to claim 1 projecting an image of the pattern onto a radiation-sensitive substrate.

19. A catadioptric projection objective comprising:
a plurality of optical elements arranged along an optical axis to image a pattern from an object field in an object surface of the objective to an image field in an image surface region of the objective at an image-side numerical aperture NA with electromagnetic radiation defining an operating wavelength λ, including:
a first objective part configured to image the pattern from the object surface into a first intermediate image, and having a first pupil surface;
a second objective part configured to image the first intermediate image into a second intermediate image, and having a second pupil surface optically conjugate to the first pupil surface, the second objective part including a concave mirror having a reflective mirror surface positioned at or close to the second pupil surface;
a third objective part configured to image the second intermediate image into the image surface, and having a third pupil surface optically conjugate to the first and second pupil surface;
wherein the concave mirror is arranged coaxial with the first objective part to receive radiation from the object surface;
a first deflecting mirror is arranged to deflect radiation reflected from the concave mirror towards a second deflecting mirror;
the second deflecting mirror is arranged to deflect radiation from the first deflecting mirror towards the image surface such that the image surface is parallel to the object surface, and
a single field lens with positive refractive power having at least one aspheric lens surface is arranged geometrically between the first deflecting mirror and the second deflecting mirror.

20. Projection objective according to claim 19, wherein the aspheric lens surface is the lens surface which faces the second intermediate image.

21. Projection objective according to claim 19, wherein no lens is arranged in addition to the field lens geometrically between the first deflecting mirror and the second deflecting mirror

22. Projection objective according to claim 19, wherein the projection objective has an image-side numerical aperture NA≧1.35.

23. Projection objective according to claim 19, wherein L1 is a geometrical distance between the object surface and an intersection point of the first section of the optical axis and a plane defined by the first deflecting mirror; L2 is a geometrical distance between the intersection point of the first section of the optical axis and the plane defined by the first deflecting mirror, and the image surface such that L=L1+L2; and the condition 1.06<A=L1/L2 holds.

24. A catadioptric projection objective comprising:
a plurality of optical elements arranged along an optical axis to image a pattern from an object field in an object surface of the objective to an image field in an image surface region of the objective at an image-side numerical aperture NA with electromagnetic radiation defining an operating wavelength λ, including:
a first objective part configured to image the pattern from the object surface into a first intermediate image, and having a first pupil surface;
a second objective part configured to image the first intermediate image into a second intermediate image, and having a second pupil surface optically conjugate to the first pupil surface, the second objective part including a concave mirror having a reflective mirror surface positioned at or close to the second pupil surface;
a third objective part configured to image the second intermediate image into the image surface, and having a third pupil surface optically conjugate to the first and second pupil surface;
wherein the concave mirror is arranged coaxial with the first objective part to receive radiation from the object surface;
a first deflecting mirror is arranged to deflect radiation reflected from the concave mirror towards a second deflecting mirror;
the second deflecting mirror is arranged to deflect radiation from the first deflecting mirror towards the image surface such that the image surface is parallel to the object surface;
wherein L1 is a geometrical distance between the object surface and an intersection point of the first section of the optical axis and a plane defined by the first deflecting mirror; L2 is a geometrical distance between the intersection point of the first section of the optical axis and the plane defined by the first deflecting mirror, and the image surface such that L=L1+L2; and the condition 1.06<A=L1/L2 holds.
a single field lens with positive refractive power having at least one aspheric lens surface is arranged geometrically between the first deflecting mirror and the second deflecting mirror.

25. Projection objective according to claim 24, wherein the projection objective has an image-side numerical aperture NA≧1.35.
